(19) United States
(12) Patent Application Publication
(10) Pub. No.: US 2023/0400166 A1
(43) Pub. Date: Dec. 14, 2023

(54) Optical Composite and Optical Arrangement for Targeted Illumination Patterns

(71) Applicant: Fusion Optix, Inc., Woburn, MA (US)

(72) Inventors: Terence Yeo, Concord, MA (US); Lee Mantha, Lawrence, MA (US); Timothy Kelly, Brookline, MA (US)

(73) Assignee: Fusion Optix, Inc., Woburn, MA (US)

(21) Appl. No.: 18/231,239

(22) Filed: Aug. 7, 2023

Related U.S. Application Data
(63) Continuation-in-part of application No. 17/829,112, filed on May 31, 2022, now Pat. No. 11,719,413.
Application No. 17/829,112 is a continuation of application No. 16/857,170, filed on Apr. 23, 2020, now Pat. No. 11,592,158.
(60) Provisional application No. 62/837,534, filed on Apr. 23, 2019.

(51) Int. Cl. F21V 5/04; G02B 5/32; G02B 3/08; F21V 7/00; F21V 13/04; F21S 4/28

(52) U.S. Cl. CPC F21V 5/045; G02B 5/32; G02B 3/08; F21V 5/04; F21V 7/005; F21V 13/04; F21S 4/28; F21Y 2115/15

(57) ABSTRACT

Disclosed are optical composites with a first portion lens of light transmissive material and a second portion backing material which in various embodiments can be reflective, transflective, black, or patterned for visual effect. Non-transmissive backing materials used in optical arrangement embodiments can be utilized to confine and redirect light propagation and also to form mounting features such as flanges and tabs. Energy savings are achieved in optical arrangements with high optical efficiency utilizing compact, durable, and aesthetically appealing optical composites and lighting arrangements capable of providing an assortment of configurable angular light distributions.

### BACKGROUND

The present disclosure relates generally to lighting systems; more specifically, the present disclosure relates to an optical arrangement for providing light distribution patterns in an environment, for example uniform light distribution patterns in an environment. Furthermore, the present disclosure relates to a lighting assembly employing the optical arrangement for providing light distribution patterns in an environment, for example for providing uniform light distribution patterns in an environment. By “uniform” is meant angularly constant within a variation limit of +/−15% from a nominal value, more optionally within a variation limit of +/−10% from the nominal value.

Generally, lighting devices are utilized in many diverse applications, such as in office workspaces, in warehouses, in educational institutions, in research laboratories, in indoor and outdoor living spaces, in industrial areas, in vehicles and so forth to provide illumination for humans performing visual tasks. Additionally, nowadays, lighting devices are also employed for aesthetic purposes in order to provide a visually comforting environment to a given person. Conventionally, lighting systems are affixed in ceilings, walls and other geometric installations to illuminate an area associated therewith.

However, there are several problems associated with the aforementioned conventional lighting devices. One major technical problem of the conventional lighting devices is that they use high-intensity discharge lamps for illumination, for example high-pressure Sodium lamps, and they are often fixed at a given position within or in a vicinity of the regions that require lighting thereby. Such lighting systems emit light radiation in a fixed lighting direction. Furthermore, these lighting systems emit a non-uniform angular distribution of light in the associated region which potentially leads to visual discomfort for users. For example, such lighting sources are susceptible to create glare, when their emitted light radiation is incident of on other surfaces and reflected therefrom.

To overcome this aforesaid problem, generally, an environment or workspace is provided with multiple small lighting devices; employing multiple devices leads to an increase in installation and maintenance costs, inefficient energy usage, wastage of resources and environmental pollution. Furthermore, one or more optical elements employed in the conventional lighting devices receives light from a light source having particular characteristics defined by the properties of the light source and then alter the light propagating through the optical element. However, none of these optical elements is capable of improving the optical qualities of the light in a manner which evens out or smoothens out the light by eliminating high-intensity spots and low-intensity spots, color banding, glare and so forth. Furthermore, the one or more optical elements employed in the conventional lighting devices do not provide a continuous diffusion of light into an environment, thereby resulting in a non-discontinuous light diffusion. Additionally, none of these types of optical elements are capable of substantially reducing or eliminating scattering of light, and of directing substantially all, or most of, light in a particular desired direction, pattern, or envelope.

Therefore, taking aforementioned problems into consideration, there exists a need to overcome the aforementioned drawbacks associated with the existing lighting devices and the existing optical elements associated therewith.

Within the fields of optics and optical design there are established relations between intensity I of a light source and Illuminance E upon an illuminated surface. These relations are dependent on trigonometric relations of distance and incident angle and can be expresses in mathematical formulas as follows:
The inverse-square law, E=I/d², states that illuminance E is inversely proportional to the square of distance where d is distance.
The cosine law, E=(I cos θ)/d², relates illuminance to the incident angle θ of light.
The cosine-cubed law, E=(I cos³θ)/h², further relates illuminance over an illumination plane to the perpendicular distance h from the light source to the illumination plane and the incident angle θ which references the perpendicular orientation.

### SUMMARY

The present disclosure seeks to provide an optical arrangement that provides, when in operation, more uniform angular light distribution emissions into an environment. Furthermore, the present disclosure seeks to provide a lighting assembly employing the optical arrangement to provide, when in operation, more uniform angular light distribution emissions into an environment. The present disclosure seeks to provide a solution to a problem of non-uniform angular distribution of light leading to visual discomfort, spatial discontinuity in output light distribution, and non-availability of optical arrangements that enhance optical properties of light emissions and smooth the light emissions. Furthermore, the present disclosure seeks to provide a solution to a problem of, for example, wastage of electrical energy due to improper lighting emissions into an environment. An aim of the present disclosure is to provide a solution that overcomes, at least partially, the problems encountered in prior art, and that provides a compact, durable, robust, and aesthetically appealing optical arrangement and lighting assembly that is capable of enhancing the optical properties of light and thereby, providing different uniform angular light distributions. Additional Embodiments of the present disclosure substantially eliminate, or at least partially address, the aforementioned problems in the prior art, and provide an improved lighting assembly to provide more uniform light distribution patterns that mitigate visual discomfort and are aesthetically appealing to a given viewer. The present disclosure further, at least partially, eliminates wastage of light energy and improves energy efficiency.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF FIGURES

The preceding summary, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein;

FIG. 1A is an exploded-view illustration of component parts of an optical arrangement having discrete optical element and reflective backing layer components;

FIG. 1B is a cross-section illustration of the optical arrangement of FIG. 1A;

FIG. 1C is a schematic illustration of an optical arrangement having discrete optical element and reflective backing layer components;

FIG. 2A is a cross-section illustration of an optical arrangement embodiment where the light source is recessed within a reflective backing layer;

FIG. 2B is a schematic illustration of a batwing intensity distribution as a polar plot, in accordance with the embodiment of FIG. 2A;

FIG. 2C is a schematic illustration of an optical arrangement embodiment wherein the reflective backing layer extends beyond the optical element and is angled to further reflect light and adjust the output light distribution;

FIG. 2D is an isometric view of a light fixture wherein the housing forms a reflector that further controls the output of the optical arrangement;

FIG. 3A is a schematic illustration of an optical arrangement comprising an optical element with extended secondary portions;

FIG. 3B is a schematic illustration of an optical arrangement comprising an optical element having a triangular cross-section, in accordance with an embodiment of the present disclosure;

FIGS. 4A-4B are schematic illustrations of an optical arrangement embodiment having a supplemental lens positioned in the optical cavity;

FIG. 5 is a cross-section illustration of an optical arrangement, in accordance with an embodiment of the present disclosure wherein the second portions of the optical element are extending in a direction perpendicular to the light source board.

FIG. 6A and FIG. 6B, show an optical arrangement embodiment with a light scattering layer at the inner face of the optical element within the optical cavity;

FIG. 7 is a schematic illustration of an optical element, further comprising surface features formed on an output face of a first portion thereof, in accordance with various embodiments of the present disclosure;

FIGS. 8A-8B are schematic illustrations of an optical arrangement comprising one or more reflectors, in accordance with different embodiments of the present disclosure;

FIG. 9 is a schematic illustration of an optical arrangement, in accordance with an embodiment of the present disclosure;

FIG. 10 is a schematic illustration of an optical arrangement comprising one or more reflective strips, in accordance with an embodiment of the present disclosure;

FIG. 11A-11B are schematic illustrations of an optical arrangement further comprising one or more slots and one or more mounting elements arranged therein, in accordance with various embodiment of the present disclosure;

FIG. 12 is a schematic illustration of optical arrangement comprising an internal support rail, in accordance with an embodiment of the present disclosure;

FIG. 13 is a schematic illustration of an exemplary lighting assembly, in accordance with an embodiment of the present disclosure;

FIG. 14A-F are illustrations of various polar emission patterns that are achieved in operation when employing various differing optical arrangement embodiments.

FIG. 15 is a table listing configuration details and optical measurement results of a group of optical arrangement embodiments and reference arrangement with order ranked by efficacy.

FIG. 16-19 illustrate the visual appearance effects of specific embodiments, FIG. 16 being focused on the appearance of embodiments with differing white backing layer options and FIG. 17-19 documenting appearance of embodiments having black backing layers.

FIG. 20-28 illustrate embodiment polar plot light distributions achieved with a corresponding different optical element geometry in each figure.

FIG. 29A-29C show three different optical elements and the corresponding polar plot light distribution produced in an optical arrangement having a white backing layer film stacked adjacent to the opposing face as in FIG. 1C.

FIG. 30A-30D illustrate a range of embodiment optical arrangements with various optical composite elements comprised of multiple materials.

FIG. 31 illustrates an embodiment optical arrangement with an optical composite element having a collimating lens structure in the first portion of the optical element.

FIG. 32 is a cross-section view illustrating an embodiment optical arrangement with an optical composite element comprising three materials.

FIG. 33 is a cross-section view illustrating an embodiment optical arrangement with an optical composite element and LED board configured to mount into a housing.

FIG. 34 is a cross-section view illustrating an embodiment optical arrangement with an optical composite element having extended second portion flanges or mounting within an optical assembly.

FIG. 35 is cross-section view of an embodiment optical arrangement with an optical composite element having a black backing layer optically coupled to the opposing face of the optical composite element.

FIG. 36A is a cross-section view of an embodiment optical arrangement with an optical composite element having a configuration to produce an asymmetric light distribution.

FIG. 36B shows an example asymmetric light distribution produced from an optical arrangement configuration of the type shown in FIG. 36A.

FIGS. 37A-37C show cross-section views of embodiment optical arrangements with optical composite elements configured for asymmetric light distributions.

FIG. 38 illustrates a particular optical element embodiment used in an optical arrangement configuration to produce the illustrated photometric data and polar plot of the optical light distribution.

FIG. 39 illustrates photometric data and polar plots of light distribution for configurations of the illustrated optical element embodiment at a range of differing diffusion levels.

FIG. 40 illustrates a cove light fixture with an embodiment optical arrangement.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In overview, embodiments of the present disclosure are concerned with an optical arrangement for providing uniform light distribution patterns in an environment. Furthermore, the embodiments of the present disclosure also provide a lighting assembly employing the optical arrangement for providing uniform light distribution patterns in an environment.

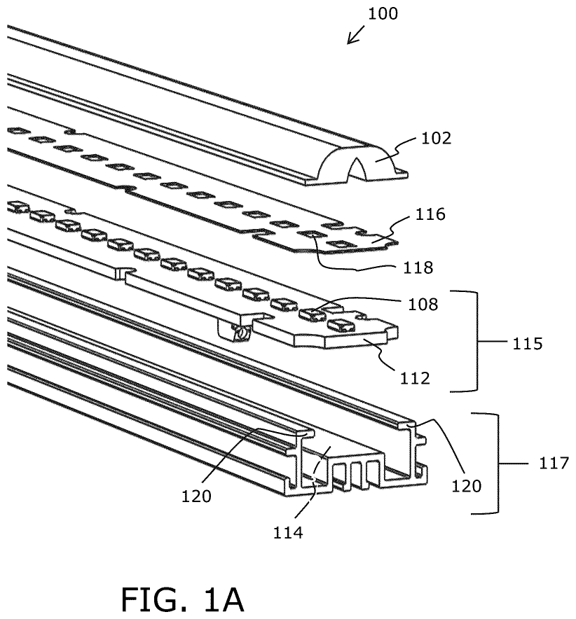

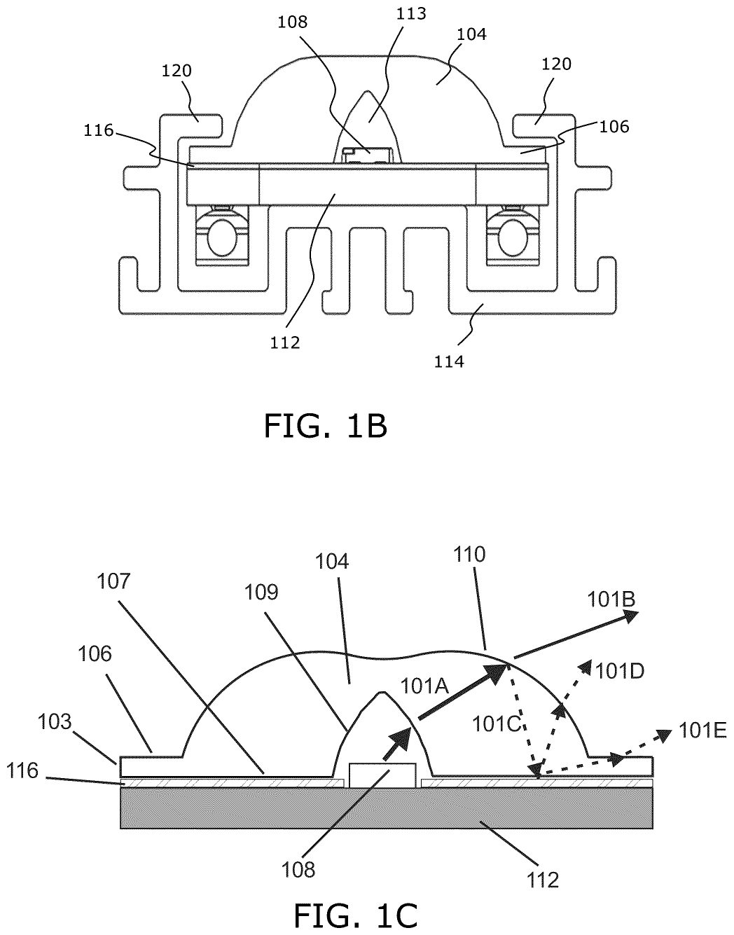

Referring to FIG. 1A, there is shown an exploded-view illustration of an optical arrangement indicated generally by 100. The optical arrangement 100 includes one or more second portions 106, wherein the one or more second portions 106 are optically light-transmissive and light-refractive when in operation. Moreover, the optical arrangement 100 includes a series of light sources 108 supported on a light source board 112, wherein a reflective backing layer 116 in the form of an elongate stencil layer includes a series of apertures 118 and is interposed between the optical element 102 and the light source board 112, and wherein the light sources 108 are aligned with their corresponding apertures 118. The optical arrangement 100 further includes a housing 117 which holds and partially encloses the optical arrangement. The housing 117 in this embodiment includes a base support 114 for receiving the light source board 112, the reflective backing layer 116 and peripheral lateral edges of the one or more optical element second portions 106 that are retained within inward-facing lips 120 of the housing 117. Optionally, the base-support 114 is fabricated from extruded aluminium, the one or more second portions 106 are fabricated from optically transmissive polymer material such as extruded PMMA (acrylic). In this embodiment the reflective layer 116 is a stencil comprising high reflectance material. The reflectance can alternatively be any combination of diffuse or specular reflectance properties. In many applications, diffuse reflectance is useful in contributing to more uniform light distributions with smoother intensity change. In other embodiments the reflective backing layer can be configured as a coating on the surface of the light source board 112. Alternatively, the reflective backing layer can be optically coupled to the opposing face 107 of the optical element wherein there is at no air gap between the reflective backing layer and the opposing face. This removes internal reflection from the opposing face of the optical element and replaces with reflection directly from the reflective surface.

Referring next to FIG. 1B, there is shown a cross-sectional illustration of the optical arrangement 100 of FIG. 1A, when in an assembled state, wherein retention of peripheral edges of the one or more second portions 106 within the inward-facing lips 120 is shown. Beneficially, the base support 114 serves as a heatsink for dissipating heat energy generated in operation from the light sources 108. The light sources 108 emit optical radiation that propagates through the optical cavity 113, wherein the optical radiation is transmitted and refracted when propagating though the optical element first portion 104 and the one or more optical element second portions. In this particular embodiment, the second portions 106 are relatively small in size and function primarily as a means of securing the optical arrangement in place. In other embodiments the size of second portions are larger and have a more significant contribution to optical output.

Referring to FIGS. 1A-IC, there are illustrated alternative schematic representations of an optical arrangement 100, in accordance with various embodiments of the present disclosure. As shown in FIG. 1A, the optical arrangement 100 comprises an optical element 102. Throughout the present disclosure, a term “optical element” as used herein relates to elements that, when placed in a beam or path of light, change characteristics of the light passing through the optical element 102. It will be appreciated that the characteristics of light such as wavelength, intensity, dispersion angle, beam angle, beam width may be varied in accordance with one or more properties of the optical element 102 arranged in the path of the light. Notably, the light incident on the optical element 102 is further guided by any of the known optical phenomena such as refraction, reflection, and/or diffraction. The optical elements 102 include, but are not limited to, a collimating lens, a refractive lens, a light guide, a diffuser and a reflector. It will be appreciated that the characteristics of the light that is output from the optical element 102 depends on one or more of the types of the optical element 102 employed, a distance of the optical element 102 from the light sources, inherent properties of the optical element 102 such as its refractive index and so forth. A design and type of optical element 102, employed for a particular optical arrangement 100, is optimized accordingly to ensure generation of concentrated light beams emitted from the optical arrangement 100 when in operation, wherein the concentrated light beams having a substantially uniform intensity distribution, eliminating banding of the emitted light, leading to effective utilization of the emitted light from the optical arrangement 100. Furthermore, the optical element 102 as disclosed herein also ensures generation of a desired light distribution pattern, and reduction of (for example, minimizing) visual discomfort arising due to improper illumination and non-uniform light distribution as encountered in conventional optical arrangements.

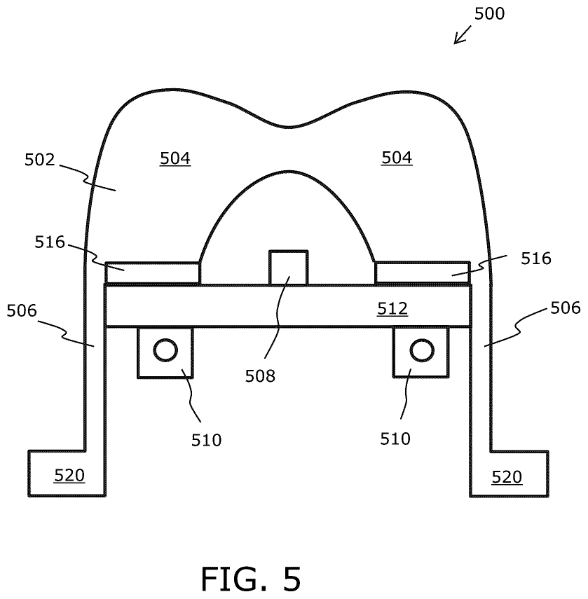

As shown, the optical element 102 comprises a first portion 104, one or more second portions 106, and a light source 108. The first portion 104 has an input face 109 and an output face 110 (clearly shown in FIG. 1C) and is shaped to provide an internal cavity 113. The internal cavity 113 is, for example, understood to be a recess formed in the first portion 104 of the optical element to accommodate one or more light sources 108. Typically, the first portion output face 110 of the optical element first portion 104 has at least one curvature. By “curvature” is meant that the first portion output face 110 has a geometric arc when viewed in cross-section. In an example, the first portion 104 is a semi-cylindrical hollow structure having a elongate length and an annular thickness. The annular thickness is a radial dimension of the first portion 104 measured from the input face 109 to the output face 110. Notably, the first portion 104 is shaped as a semi-cylindrical hollow structure to provide the internal cavity 110. It will be appreciated that the shape of first portion 104 is not limited to a semi-cylindrical hollow structure as shown. The different shapes (in cross-section) of the first portion 104 include, but are not limited to, triangular (as shown in FIG. 5), cuboidal, elliptical, paraboloidal, or any other desired abstract shape having the input face 109 and the output face 110, shaped to provide an internal cavity 113.

Referring next to FIG. 1C, there is shown a cross-section view of the optical arrangement of the embodiment without the housing structure. The optical arrangement comprises the optical element 102 having the first portion 104 having the input face 109 and the output face 110, the one or more second portions 106 and the light source 108. The light source 108 is a LED mounted on an light source board 112 with a reflective backing layer 116 positioned between the optical element and the LED board is arranged inside the internal cavity 113 to emit light, such that light emitted from the light source 108 enters the first portion 104 illustrated by an example light ray 101A that propagates to the first portion output surface 110. Light ray 101B illustrates and example of a light ray subsequently transmitted through the first portion output surface 110 while light ray 101C illustrates an example of internal reflection wherein the light ray is subsequently reflected from the reflective backing layer 116 and light ray 101D transmits out the optical element first portion 104 while light ray 101E transmits out the optical element secondary portion 106. The blending of light output from the first portion surface 110, such as light ray 101B, with light output from the reflective backing layer 116, such as light ray 101D, and in some embodiments 101E, is an effective way to improve visual appearance of the light distribution pattern by reducing non-uniformity defects such as bright spots, dark spots, banding effects, and color separation. Addition of diffuse reflectance in many cases is particularly useful.

The light source board 112 is a circuit board that beneficially serves as a support platform for the light source 108. In an example, the light source board 112 beneficially provides mechanical support to the light source 108, as well as provides electrical functionality to the light source 108. Throughout the present disclosure, the term “light source” as used herein refers to any electrical device capable of receiving an electrical signal and producing electromagnetic radiation or light in response to the signal. The light sources 108 are optionally configured to generate electromagnetic radiation within the visible spectrum, outside the visible spectrum, or a combination of both. The term “light” is used when the electromagnetic radiation is within the visible ranges of frequency and the term “radiation” is used when the electromagnetic radiation is outside the visible ranges of frequency. Notably, the light sources 108 may be configured for a variety of applications, including, but not limited to, indication, display, and/or illumination. Generally, the light sources 108 are particularly configured to generate light having a sufficient intensity to illuminate effectively an interior or exterior environment or targeted area. In this context, “sufficient intensity” refers to a sufficient radiant power in the visible spectrum generated in the space or environment. The unit “lumens” is often employed to represent the total light output from the light source 108 in all directions, in terms of radiant power or luminous flux. The light sources 108 optionally use lights of any one or more of a variety of radiating sources, including, but not limited to, Light Emitting Diode LED-based sources (including one or more LEDs), electroluminescent strips, incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources such as, photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

The light source board 112 optionally includes one or more threaded holes, through-holes, and/or locating features. The printed circuit board 112 beneficially has any suitable shape, such as a round shape, a square shape, a rectangular shape, a hexagonal shape, and so forth. Herein, the printed circuit board is rectangular in shape, as an example. Optionally, light source 108 comprises two or more light emitting diodes (LEDs) arranged at one or more levels with respect to each other inside the internal cavity, to provide different light distribution patterns via transmission and refraction occurring in the optical element 102. For example, the support platform optionally also includes the mechanical and electrical connections required to elevate the LEDs 108 to a suitable distance above the actual printed circuit board plane. The LED array is optionally arranged in a rectangular pattern, or any other suitable pattern. Furthermore, each of the LEDs 108 that is arranged on the printed circuit board 112 is circumscribed by an encapsulating lens. In general, light emitted from a typical LED module has a Lambertian distribution pattern. A Lambertian distribution pattern has a peak that is oriented normal to the emitting surface (namely, the plane of the LEDs), often denoted as 0 degrees, with an angular fall-off of cos θ, where θ is an angle with respect to the surface normal. In an example, the LED module with the LED light source 108 and the optical element 102 are fixed to each other by gluing, soldering, welding, screwing, snapping, or any other suitable attachment method.

In all embodiments the optical element is composed of a light transmissive material. Optionally, the light transmissive material is a polymer or glass (for example, Silicon Dioxide), crystalline materials, polymers or plastics materials having a suitable refractive index in accordance with one or more desired light distribution patterns. In an example, the light transmissive material includes, but is not limited to, Polymethyl methacrylate (PMMA), polycarbonate (PC), silicone, polyethylene terephthalate (PET), Polyethylene naphthalate (PEN), and cyclic olefin copolymer (COC). In some embodiments the light transmissive material is clear and of homogeneous composition. In other embodiments, light transmissive material has a degree of light scattering properties which contribute to a more uniform light distribution pattern, in particular, smoothing out “hot spots”, “banding”, “color dispersion”, “beam artifacts” and other irregularities in light distribution which are visibly noticeable to the human eye when projected onto a surface, for example, an wall, ceiling, or floor. Light scattering properties can be introduced to an optical element by imparting surface features or texture to a surface, or stated another way, by removing a gloss surface. Alternatively or in combination with surface modification, the volume of the optical element can be given light scattering properties by inclusion of regions of differing refractive index dispersed throughout the volume. For example, one or more particle types having refractive index different than the bulk material can be dispersed within the volume. Alternatively, second phase regions of differing refractive index can be formed by fluid phase mixing of immiscible materials during processing. In addition to refractive index difference of dispersed material vs. bulk material, the quantity per volume, size, and shape of dispersed regions can be adjusted to effect light scattering properties. In the case of immiscible blends formed by fluid phase mixing, the shape of one or more regions are optionally other than spherical, for example oblate paraboloid, thereby generating non-symmetric light scattering. It will be appreciated that the concentration of dispersed regions of differing refractive index is an important variable in effecting light scattering properties that influence angular light distribution and uniformity of beam pattern.

Optical composites comprised of multiple materials can be produced by various manufacturing processes including coextrusion. co-molding, or multi-material injection molding. Coextrusion is particularly feasible process for producing continuous runs of optical composites that can be cut to length for particular applications. Thermoplastic materials are thermally fused in the molten state and cooled to solidity. Acrylic (PMMA/polymethyl acrylate) is a common and useful thermoplastic material for optical composites. Other thermoplastic materials include but are not limited to; polycarbonate (PC), polyethylene terephthalate (PET), Polyethylene naphthalate (PEN), and cyclic olefin copolymer (COC). Thermoset materials are joined in fluid state and then cured, for example by heating or UV exposure. Silicone and UV curable acrylates are examples of thermoset materials for optical composites.

Optionally, the first portion 104 functions as a lens structure, the lens structure being one of a convex lens, a concave lens and a Fresnel-type flat lens. Notably, the term “lens structure” as used herein refers to an optically transmissive structure that is configured to focus or disperse light according to a defined light distribution pattern. Herein, the light enters from the input face 109 of the lens structure and exits from the output face 110 of the lens structure. In an example, when the first portion 104 functions as a concave lens, the first portion 104 is designed to be thinner at the center and thicker at the edges. It will be appreciated that the concave lenses are diverging lenses, and therefore when the light emitted from the light source 108 enters the concave lens, the light beam is refracted and diverged from the output face 110 to provide a wide-angle or a broad beam width spreading the light into the environment. In another example, when the first portion 104 functions as a convex lens, the first portion 104 is designed to be thicker at the center thereof and thinner at edges thereof. It will be appreciated that the convex lenses are converging lenses, and therefore when the light emitted from the light source enters the convex lens, the light beam is refracted and converged from the output face 110 to provide a collimated beam, such as the one used in spot lights. In another example, the first portion 104 may be as simple as a conventional cylindrical lens where a beam of light entering the lens remains unaffected in its width and is spread by the cylindrical lens contour in a direction perpendicular to its width. Another example of the first portion 104 of the optical element 102 is a transparent medium having a flat surface on one side and a concave or convex surface on the other side which changes the characteristics of light passing through the lens providing a desired light distribution pattern; for example, the optical element 102 is fabricated from a optically-refractive material have a spatially-varying refractive index.

In another example, the lens structure is a Fresnel-type flat lens. Herein, the first portion 104 is designed to have a Fresnel-type flat lens consisting of a flat surface with interspaced, concentric steps, wherein each step corresponds to a surface of a conventional lens. It will be appreciated that each step acts as a refractive surface like a prism. Notably, Fresnel lenses are thinner as compared to conventional lenses, and produce and extremely collimated light beam without distorting light out of the light beam. Optionally, a Fresnel lens includes a plurality of Fresnel structures provided on a surface of the lens which bend or refract the light in order to collimate or focus the light passing through the lens. Such structures are capable of directing substantially all of the light emitted from the light source 108 in a particular direction and in a particular shape, envelope, or pattern. One or more other type of lens structures optionally include but are not limited to, (diffraction) grating structures, filters, total internal reflection (TIR) structures, non-linear optical elements such as GRIN lenses, prismatic structures, polarizers, pillow optic formations, optical fiber waveguides and other types of optical waveguides.

Optionally, light transmissive material in the first portion 104 is distributed such that the provided lens structure has sections with varying focal points in relation to a light source. Optionally, the first portion 104 optionally comprises a plurality of sections having mutually different refractive indices. When the light emitted from the light source 108 enters the mutually different sections, the light is refracted and collimated to respective focal points in accordance with the refractive indices of respective sections of the optical element. In an example, the first portion 104 is divided into 5 sections of varying focal lengths namely, F1, F2, F3, F4 and F5. When the light from the light source 108 is incident on the first section having focal length F1, the light beam emanating from the output face 110 sharply illuminates a first area on a floor, wall or ceiling associated therewith. When the light from the light source 108 is incident on the second section having focal length F2, the light beam emanating from the output face 110 sharply illuminates a second area on a floor, wall or ceiling associated therewith. When the light from the light source 108 is incident on the second section having focal length F3, the light beam emanating from the output face 110 sharply illuminates a third area on a floor, wall or ceiling associated therewith. When the light from the light source 108 is incident on the fourth section having focal length F4, the light beam emanating from the output face 110 sharply illuminates a fourth area on a floor, wall or ceiling associated therewith. Similarly, when the light from the light source 108 is incident on the fifth section having focal length F5, the light beam emanating from the output face 110 sharply illuminates a fifth area on a floor, wall or ceiling associated therewith. It will be appreciated that each of the sections of the lens are susceptible to being utilized simultaneously, or only one section, or a combination of one or more sections are susceptible to being utilized by one or more light source 108 to provide a more uniform light distribution pattern, as well as define an illumination area as and when required.

In various embodiments the optical element 102 may comprise one or more second portions 106 extending from the first portion 104. Each of the one or more second portions 106 may extend from each of lateral ends of the first portion 104. It will be appreciated that one or more second portions 106 may be flanges or mounting tabs extending from diametric ends of the first portion 104. Each of the one or more second portions 106 may be substantially cuboidal in shape, having a longitudinal length same as a length of the first portion 104, and a thickness same as an annular thickness of the first portion 104. Furthermore, each of the second portions 106 may be substantially parallel to the light source 108. It will be appreciated that the optical element 102, together with the first portion 104 and the second portion 106 can be provided as a monolithic structure. This reduces the number of components and simplifies assembly. Optionally, the second portion 106 is composed of a second material that is different from the first material. The second material optionally has a refractive index that is different to a refractive index of the first material. The one or more second portions 106 may optionally function as a light-guide, causing total internal reflection of the emitted light from the light source 108 received therein, thereby to redirect the emitted light. A primary purpose of the one or more second portions 106 in some embodiments is to redirect light that enters into the one or more second portions 106. In these embodiments, the light rays undergo total internal reflection without being significantly absorbed or transmitted (for example, less than 10% absorbed therein). It will be appreciated that the total internal reflection occurs when a ray of light strikes an interface between two regions have mutually different refractive indices, at an angle less than a critical angle of the interface, wherein the critical angle is defined by Snell's Law using the mutually different refractive indices. In an example embodiment, if the second portion has a particular refractive index, say “n”, the critical angle inside the second portion 106 at the second portion 106 and air interface is given by sin⁻¹(1/n). Therefore, the one or more second portions 106 are designed so that if a light ray leaves the LED light source 108 and strikes any of the one or more second portions 106, it does so at an angle greater than the critical angle. Optionally, the one or more second portions 106 may serve as flanges that connect the optical element to the LED module.

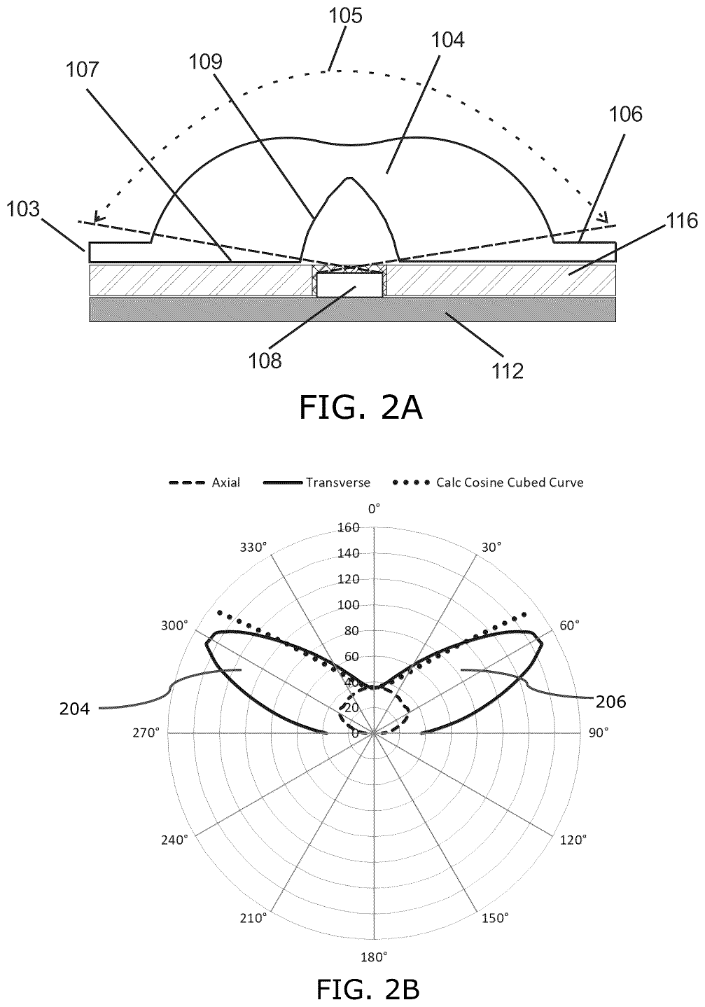

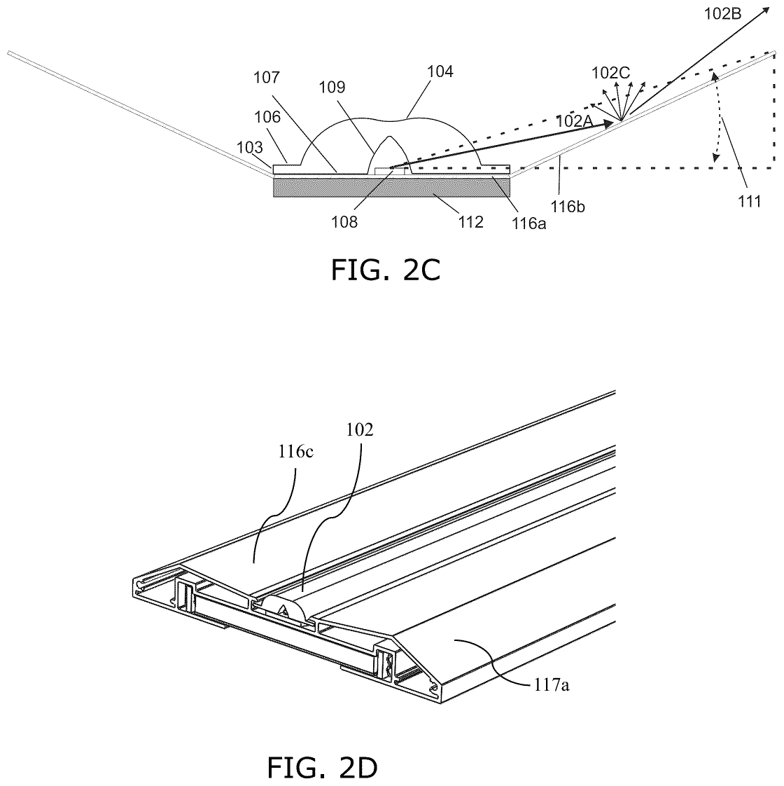

FIG. 2A is a cross-section illustration of an optical arrangement embodiment wherein the light source 108 is recessed within a reflective backing layer 116 and the opening in the reflective backing layer functions as an aperture and constrains the angular input angle 105 of the light source projecting into the optical element so that light is only projected into the first portion 104 of the optical element and light is not directly projected into the second portions 106 of the optical element. This diminishes the transmission of light out the second portions 106 in, and out the edge face 103 in particular. Additional numbered features in FIG. 2A function similarly as described in FIG. 1C; light source board 112, first portion 104 of the optical element, opposing face 107 of the optical element, and input face 109 of the optical element.

The optical arrangement as illustrated in FIG. 2A converts the typically Lambertian intensity distribution of a light source into a uniform intensity distribution pattern, such as, a batwing configuration. One known approach to achieve a uniform illumination of a surface area is to use a so-called “batwing intensity distribution” (also referred to as “a wide beam intensity distribution”). The term “batwing” refers to a highly dual peaked shape of the intensity distribution in a polar plot.

In FIG. 2B, there is shown an example of a desired batwing intensity distribution as a polar plot in accordance with an embodiment of the present disclosure. Two wings 204 and 206 in this example polar plot have a peak intensity at 60 degrees each side of a normal angle, and an aim of such an implementation is to provide a uniform surface illumination of a target area such as a ceiling or a floor over an angular range. Per the known cosine-cubed law of illumination, there is required an intensity that is increasingly higher at higher angle because there is a target surface area having its center aligned perpendicular with the 0 degree orientation and illumination with angular variation from that alignment is proportional to cos³θ where θ is the angular diversion from 0 degree. The optical design thus needs to change the Lambertian intensity distribution from a LED output intensity into the batwing distribution. It will be appreciated that the batwing intensity distribution allows for a uniform illumination of a planar surface. The polar plot of FIG. 2B plots both the actual light distribution of an embodiment optical arrangement and the theoretical calculated cosine-cubed curve. It can be seen that the two closely match up to an angle of about 45 degrees from normal (0 degree). Such light distributions and hence lens designs are beneficially used, for example, in architectural lighting, in street lighting, in car parks and in wall washer applications. In these examples, the batwing intensity distribution targets a planar surface in a far field, with an illuminated surface positioned at a distance much larger than light module dimensions. The light distribution optionally however is also applicable for short range illumination.

FIG. 2C is a schematic illustration of an optical arrangement embodiment wherein the reflective backing layer extends beyond the optical element and is angled to further reflect light and adjust the output light distribution. The embodiment of FIG. 2C represent the same optical arrangement embodiment of FIG. 1C but with the addition of a supplemental reflector 116b that is positioned to redirect light from the supplemental reflector angular input range 111. Example light ray 102A is projected from the light source 108 through the optical element first portion 104 and intersects with the supplemental reflector 116b. From the supplemental reflector 116b, example light ray 102B is a specular reflection of light ray 102A and example light rays 102C illustrate light ray 102A being converted to diffuse reflection wherein rays are widely scattered. In many applications, diffuse reflectance from either a reflective backing layer 116a or supplemental reflector 116b can be useful in making illumination patterns more smooth and uniform which typically improves visual appearance. In FIG. 2C, the supplemental reflector is configured as an extension of the reflective layer 116a but in other embodiments the supplemental reflector could be a separate component or integrated into the housing.

FIG. 2D is an isometric view of a light fixture with end cap removed wherein the housing forms a reflector that further controls the output of the optical arrangement. The supplemental reflector 116c is a surface on the fixture housing 117a that holds and partially encloses the optical arrangement including the optical element 102.

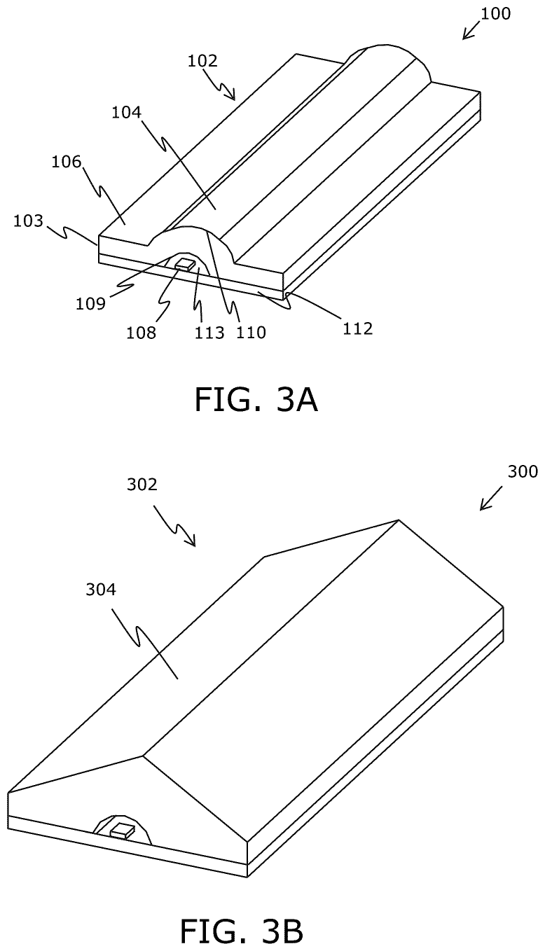

FIG. 3A is a schematic illustration of an optical arrangement comprising an optical element 102 with enlarged secondary portions 106 as compared to the first portion 104. The enlarged second portions are both wider and thicker than previously illustrated embodiments of FIGS. 1 & 2. The enlarged second portions enable more light to output from the second portions 106 and less light to emit from the first portion 104, a balance of light output that is advantageous in some applications. One effect is that the emitting area of the optical element is enlarged and with light output spread over the entire optical element, the visual brightness appearance of the optical element is reduced. This can be important in applications where the optical element is directly visible to the human eye. Specifically, the discomfort of glare can be reduced in illuminated spaces that are occupied by humans or other animals. Additional benefits in unique illumination patterns can also be achieved. For example, more light can optionally be directed to emit for the edge face 103 of the optical element.

Referring next to FIG. 3B, there is shown an illustration of an optical arrangement 300 comprising an optical element 302 having a substantially triangular cross-section, in accordance with an embodiment of the present disclosure. Such an optical arrangement 300 having a triangular optical element 302 ensures that a light output from an output face 304 has a uniform angular distribution. Beneficially, the output light rays are refracted in a manner such that the output rays are normal to the surface of the output face 304 of the optical element 302. Herein, optionally, a triangular lens employed is an isosceles triangle having an apex angle varying in a range of about 70 degrees to 120 degrees, thereby producing a high illuminance distribution having a wide angular output.

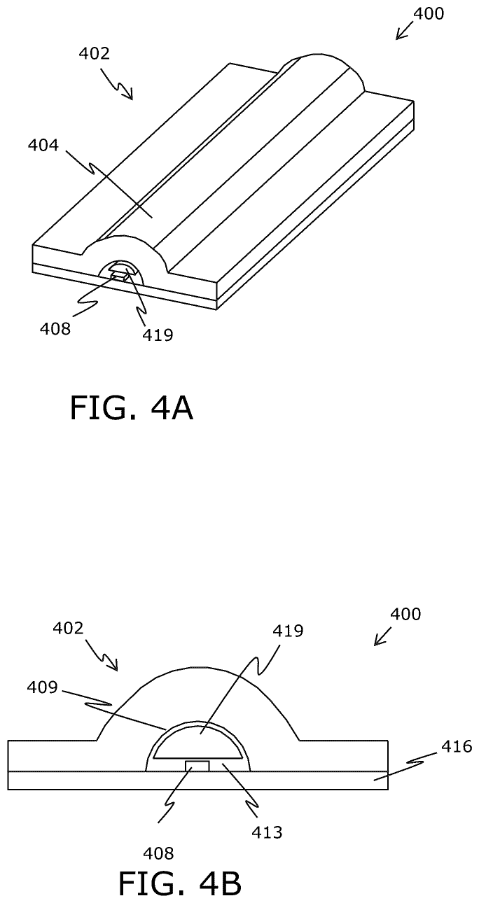

Referring next to FIG. 4A-4B, there are shown illustrations of an optical arrangement embodiment 400 wherein an additional supplemental lens 419 is positioned inside the internal cavity 410 between the light source 408 and input face 409 of the optical element 402. The supplemental lens 419, depending on specific configuration, functions to do one or more of the following; 1) redirect light in a focusing manner, 2) scatter light to redirect light within the optical element in order to a) adjust and optimize beam output distribution and/or uniformity, b) reduce glare by obscuring direct view and reducing peak brightness of the light source. Light scattering properties can be configured in the volume of the supplemental lens by the inclusion of second phase regions of differing refractive index as described in paragraph 0044. It will be appreciated that such an arrangement can provides an aesthetically appealing linear glowing strip within the optical element; i.e. a “virtual filament” generating a uniform light distribution pattern. In an example, a supplemental lens 402 operates to receive a plurality of light beams emitted from each of the light sources 408 such as LED sources arranged on the LED board and impart homogeneity to different light beams, thereby producing a more uniform light distribution pattern spread over a wide angle.

FIG. 5 is a cross-section illustration of an optical arrangement, in accordance with an embodiment of the present disclosure wherein the second portions of the optical element are extending in a direction perpendicular to the light source board.

Referring to FIG. 5, there is shown a cross-section view illustration of an exemplary implementation of an optical arrangement 500. The optical arrangement 500 includes a first portion 504 of the optical element, one or more second portions 506, one or more LEDs 508 mounted on a light source board 512 that functions as a supporting substrate. The one or more second portions 506 include leg regions 520 that engage with a housing (not shown), for example in a manner as illustrated in FIG. 13. Electrical connectors 522 are included on the light source board 512, on the opposite side and remote from the one or more LEDs 108, as shown. There is also included a reflective backing layer 516 between the optical element 502 and the light source board 512 to provide improved light output control and efficiency of the optical arrangement 500. An advantage of this embodiment is that the second portions raise the first portion 504 of the optical element, along with the light source board 512, above the housing to reduce the amount of light trapped in the housing.

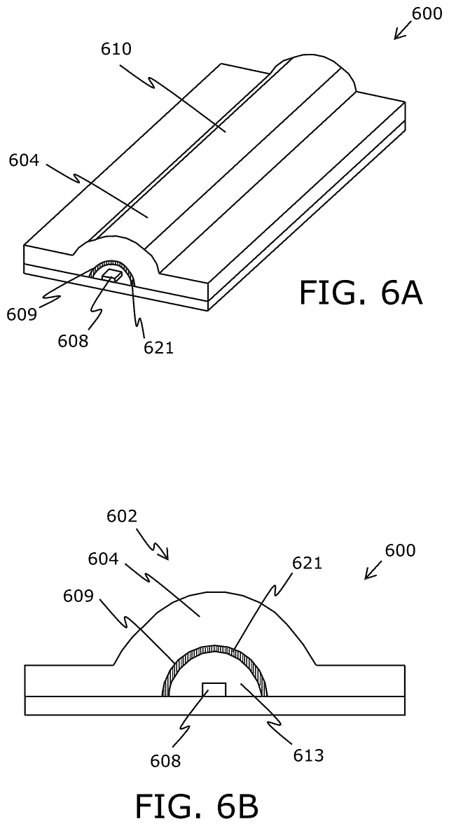

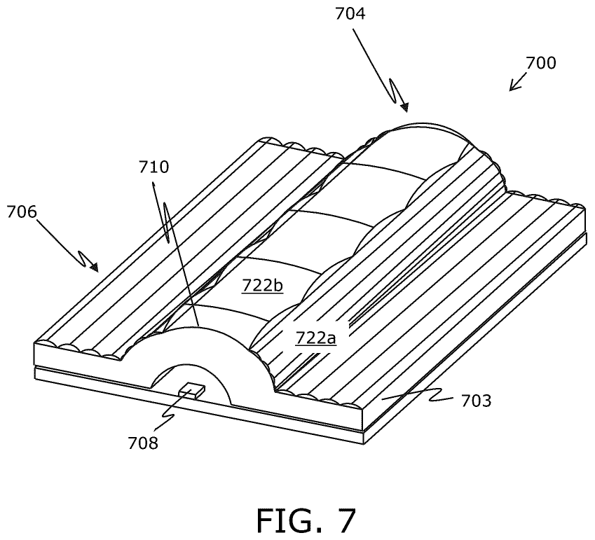

Referring next to FIG. 6A and FIG. 6B, there is shown an optical arrangement 600 comprising a light scattering layer 621 on an inner face 609 of a first portion 606 of the optical element 602 facing a light source 608, to modify light distribution of the optical arrangement and also decrease the observed peak brightness of the optical arrangement to reduce glare. The size and shape of the optical cavity 613 can be adjusted to optimize the light output and appearance of the optical arrangement. The light scattering layer 602 can be comprised of a combination of surface and/or volumetric features, with volumetric light scattering compositions described in paragraph 0044. The light scattering layer 621 can be alternatively formed by methods including but not limited to coextrusion along with the optical element or coating and curing by means of UV exposure, temperature, or humidity.

Referring to FIG. 7, there is shown an optical element 700 further comprising surface features 722 formed on a first portion output face 710 of a first portion 704 of the optical element to redirect light from the first portion 704 to an ambient environment, in accordance with an embodiment of the present disclosure. Throughout the present disclosure, the term “surface features” refers to an arrangement of optical features formed on the outer face of the first portion 704 and each of one or more second portions 706 to redirect light as incident on an inner face of the first portion and the one or more second portions 706 respectively, at different desired angular distributions by a way of refraction, diffusion, reflection, scattering and so forth. Optionally, the surface features 702 are arranged in a pattern. Herein, when light is output from such surface features 702, the surface features 702 produce a light output having an angular distribution with a more smooth, consistent and continuous intensity. It will be appreciated that the surface features 702 are configured to modify the direction of light emitted from a light source 708 so as to shape the light output into a desired light distribution pattern or envelope.

In the illustrated embodiment, the surface features 722 comprise a combination of a lenticular pattern 722a which orients in an axial direction and an embossed lenticular pattern 722b which orients in a transverse direction. Optionally, surface features vary in shape, size and also a spacing between two adjacent surface features varies. Optionally, the surface features comprise a full or partial geometric shape of one or more of a polygon, a truncated polygon, a concave polygon, a convex polygon, a sphere, an arc, a parabola, an ellipse, a paraboloid, an ellipsoid, a polyhedron, and a polyhedron frustum.

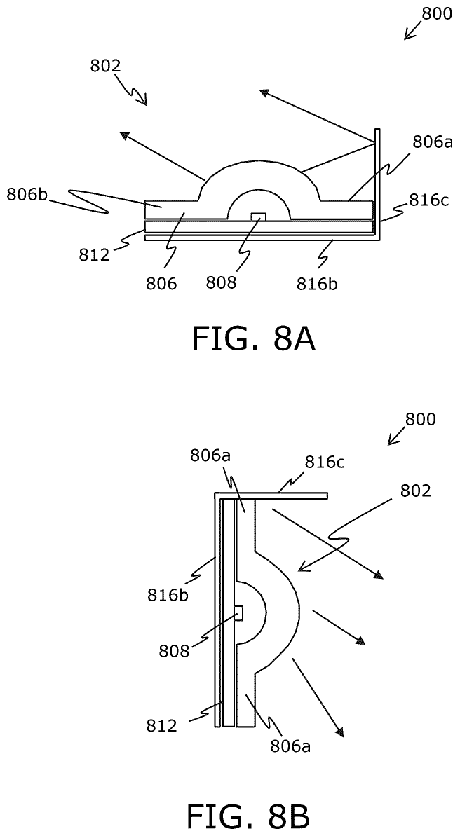

Referring to FIGS. 8A and 8B, there is shown illustrations of an optical arrangement 800 comprising one or more reflectors, in accordance with different embodiments of the present disclosure. As shown, the optical arrangement 800 comprises an optical element 802 (such as the optical element of FIG. 1), a light source 808 (such as the light source of FIG. 1), a reflective light source board 812 arranged underneath the light source 808 and one or more supplemental reflectors (depicted as reflectors 816b and 816c). Notably, the reflectors 816b and 816c are located along one or more of the reflective light source boards 806 and at least one of one or more second portions 806 of the optical element 802 to redirect emitted light further to provide a desired pattern of emitted light. It will be appreciated that the one or more reflectors 816b, 816c act as light redirecting planes that are employed to create a wall wash light distribution pattern and/or a cove light distribution pattern of the emitted light. Notably, such light distribution patterns are beneficial to employ where a more uniformly illuminated surface is desired, and a target plane orientation is not perpendicular from the optical arrangement 800. Moreover, the reflectors 816b, 816c located along one or more of the reflective light source boards 806 and at least one of the one or more second portions 806a, 806b of the optical element 802 redirects light to generate an asymmetric light distribution.

Throughout the present disclosure, the term, “reflector” used herein refers to a device for reflecting the light emitted from the light source 804 in a manner that the emitted light is redirected to provide a desired pattern. Examples of the reflector 816b, 816c include, but are not limited to, a piece of glass, a metal component, a mirror, and the like. Notably, the one or more reflectors 816b, 816c may have a reflecting surface of non-specular reflectance. The non-specular reflectance refers to a reflection of light from a surface in a manner that the light is reflected (namely, scattered) at many angles from the surface of the reflector 816b, 816b. In such a case, a luminous intensity of the reflected light appears to be uniform throughout the reflecting surface when viewed from different angles.

In an example, the optical arrangement 800 comprises a first reflector 816b and a second reflector 816b, wherein the first reflector 816b is located along the reflective light source board 812 and the second reflector 816c is located along a second portion 806a of the optical element 802. In another example, the optical arrangement 800 comprises a single reflector, wherein a shape of the single reflector is selected in a manner, like being “L”-shaped, such that the single reflector is located along the reflective light source board 812 and a second portion 806a of the optical element 802.

FIG. 8A and FIG. 8B are the same optical arrangement but mounted in different orientations so that the embodiment of FIG. 8A is well suited for wall grazing or cove lighting while the embodiment of FIG. 8B is well suited for a ceiling mounted wall washing application.

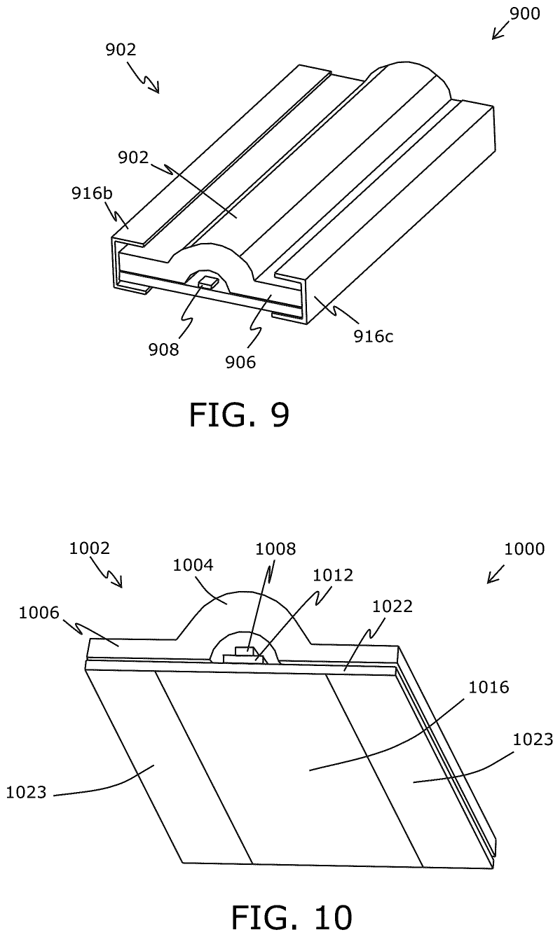

Referring to FIG. 9, there is shown a schematic illustration of an optical arrangement 900, in accordance with an embodiment of the present disclosure. As shown, the optical arrangement 900 comprises an optical element 902 (such the optical element of FIG. 1), a light source 908 (such the light source of FIG. 1), and one or more reflectors 916b and 916c wrapped around one or more second portions 906 of the optical element 902. Notably, the one or more second portions 906 function as a light-guide, causing total internal reflection of the emitted light from the light source 908 received therein, to redirect the received light thereby, and the reflectors 916b and 916c redirect the received light back into the first portion of the optical element 902 in a manner that light is directed to the environment via an output face of the optical element 902.

Referring next to FIG. 10, there is shown a schematic illustration of an optical arrangement 1000 comprising one or more reflective strips, in accordance with an embodiment of the present disclosure. As shown, the optical arrangement 1000 comprises an optical element 1002 (such the optical element of FIG. 1), a light source 1008 (such the light source of FIG. 1), a light transmissive opposing sheet 1022 arranged underneath the light source board 1012 and one or more reflective strips 1016 that are optically coupled to the opposing sheet 1006 to reflect light exiting from the opposing sheet 1006 back into the optical element 1002. Beneficially, the light exiting from the opposing sheet 1006 back into the optical element 1002 is reflected in a manner that an increased (for example, maximum) amount of light is spread in the ambient environment from an output face of the optical element 1002 to provide a desired illumination pattern. Light transmitting through the light transmitting surfaces 1023 of the light transmissive sheet create a direct-indirect light fixture with light projecting from both sides of the light transmissive opposing sheet 1022.

In further embodiments, the optical arrangement 1000 comprises multiple reflective patterns on the light transmissive opposing sheet which can be arranged to control direct-indirect light distribution as well as visual appearance and aesthetic perception. The light transmitting sheet can be configured with clear or light scattering properties as described in paragraph 0044.

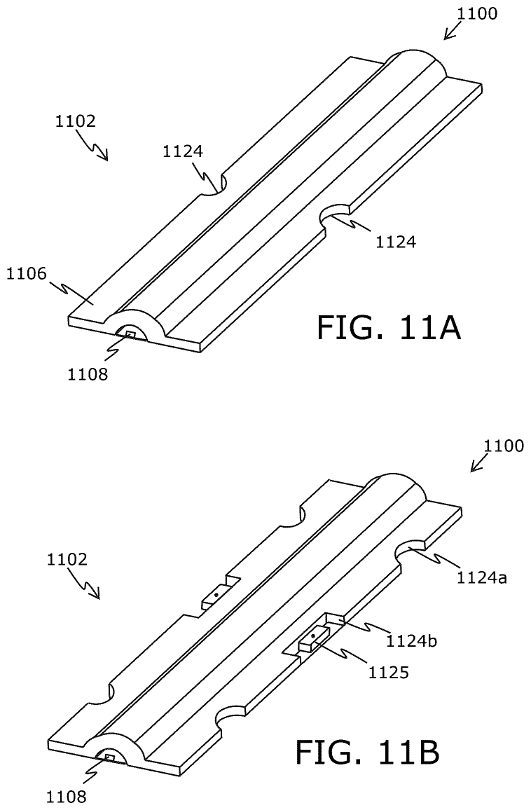

Referring next to FIGS. 11A-11B, there are shown schematic illustrations of an optical arrangement 1100, in accordance with various embodiment of the present disclosure. As shown, the optical arrangement 1100 comprises an optical element 1102 (such the optical element of FIG. 1) and a light source 1108 (such the light source of FIG. 1). Notably, one or more second portions 1106 comprise one or more slots 1124 formed therein to allow access to electrical connectors 1122.

As shown, particularly in FIG. 11B, the one or more electrical connectors 1122 are positioned within the one or more slots 1124a or 1124b in a manner that a supporting structure is provided to the optical arrangement 1100. In an example, the one or more second portions 1106 of the optical element 1102 comprises a single slot 1124 on each of the one or more second portions 1106 along the length of the optical element 1102, or alternatively the one or more second portions 1106 of the optical element 1102 comprise a plurality of slots 1124a and 1124b on each of the one or more second portions 1106.

Optionally, the one or more slots 1124a or 1124b formed within the one or more second portions 1106 provide a space within which a controller is accessible. Such a controller is optionally employed to control operation (namely, functioning) of the optical arrangement 1100 and control the light source 1104 in a manner that desired lighting arrangement can be achieved.

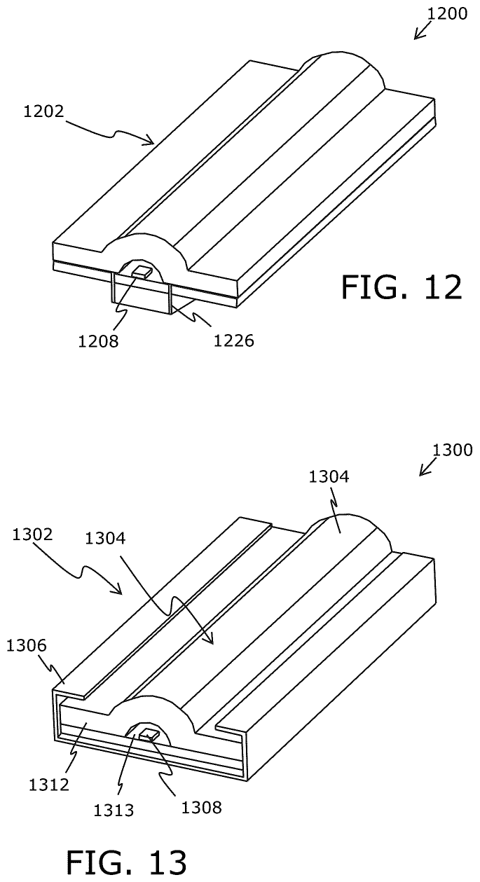

Referring next to FIG. 12, there is shown an optical arrangement 1200 (such as the optical arrangement of FIG. 1) comprising an internal support rail, in accordance with an embodiment of the present disclosure. As shown, the optical arrangement 1200 comprises an optical element 1202 (such as the optical element of FIG. 1), a light source 1208, and an internal support rail 1226. In such an example embodiment, the internal support rail 1226 is positioned in a manner that the internal support rail 1226 provides a support to the light source 1208. Notably, one or more ends of the internal support rail 1226 optionally extend inside the optical element 1202 in a manner that no obstruction is faced by the emitted light inside the optical element 1202. Such a construction of the internal support rail 1226 beneficially provides flexibility in design of the optical configuration and enhances the visual appearance of lighting assembly without affecting the light distribution thereof when in operation.

Referring next to FIG. 13, there is shown an illustration of an exemplary lighting assembly 1300, in accordance with an embodiment of the present disclosure. The lighting assembly 1300 comprises an optical arrangement 1302 (such as the optical arrangement of FIG. 1) including an optical element 1302 and a housing 1306 supporting the optical arrangement 1302. Notably, the optical element 1302 comprises a first portion 1304 having an input face and an output face, and is shaped to provide an internal cavity 1313, and one or more second portions 1312 extending from the first portion 1304. Moreover, the optical element further includes a light source 1308 arranged inside the internal cavity 1313 to emit light. Herein, the light emitted from the light source 1308 enters the first portion 1304 and the one or more second portions 1312, wherein the one or more second portions 1312 function as a light-guide causing total internal reflection of the emitted light from the light source 1308 received therein, to redirect received light thereby. The housing 1306 has one or more features to allow for mounting or attachment of the lighting assembly to a physical structure in a ceiling or a wall of a building.

The term “lighting assembly” as used herein generally refers to any lighting assembly for use both in general and specialty lighting arrangements, for example fixtures. The term general lighting includes use in living spaces such as lighting in industrial, commercial, residential and transportation vehicle applications. The term specialty lighting includes emergency lighting activated during power failures, fires or smoke accumulations in buildings, microscope, stage illuminators, and billboard front-lighting, hazardous and difficult access location lighting, backlighting for signs, agricultural lighting and so forth.

The term “housing” as used herein refers to an outer covering that encloses and supports the optical arrangement 1302. Notably, the housing 1306 has a hollow space in order to accommodate the optical arrangement therein. Beneficially, the housing supports various components of the optical arrangement 1300 for example, such as the optical element 1302, light source 1308, and so forth. Notably, the housing 1306 holds the light source 1308 and the optical element 1302 in place, thereby allowing the emitted light from the light source 1308 to enter the optical element 1302 via the input face of the first portion 1304 of the optical element 1302.

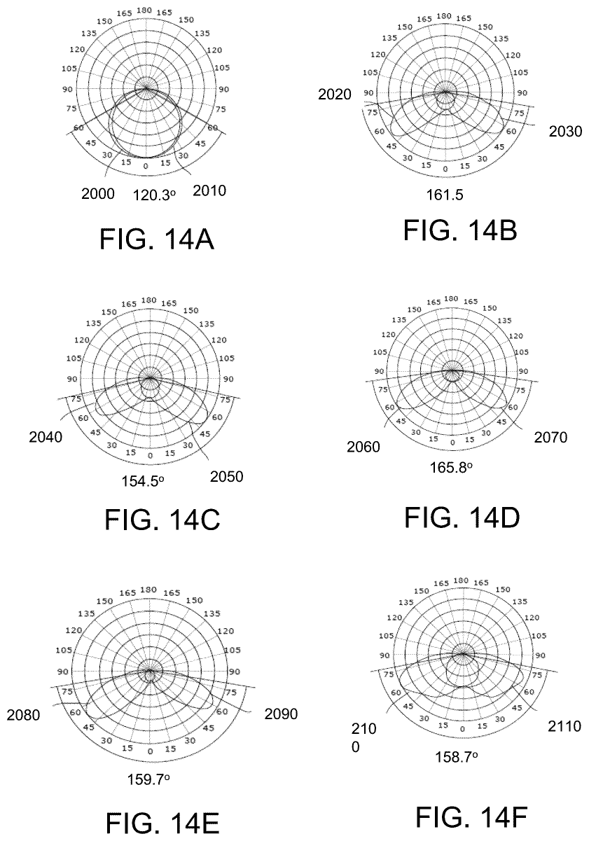

Referring to FIG. 14A-F, there are shown polar plots of emission characteristics of optical arrangements pursuant to the present disclosure. In FIG. 14A, a single polar lobe 2000, 2010 is emitted having an angular extent of 120.3°; such a single polar lobe 2000, 2010 provides highly effective illumination in a downwards direction when 0° corresponds to a vertical axis. However, it is more usual in the optical arrangement to provide two polar lobes that are have various polar angles of emission, for example two polar lobes 2020, 2030 providing 161.5° in FIG. 14B, two polar lobes 2040, 2050 providing 154.5° in FIG. 14C, and two polar lobes 2060, 2070 providing 165.8° in FIG. 14D, in a symmetrical manner about 0°. By suitable asymmetrical design of refractive elements of the optical arrangement, an asymmetrical polar distribution of two lobes 2080, 2090 providing 159.7° can be achieved, as illustrated in FIG. 14E. Moreover, more complex shapes to lobes 2100, 2110 of emission are feasible as illustrated in FIG. 14F and provides an illumination range of 158.7°.

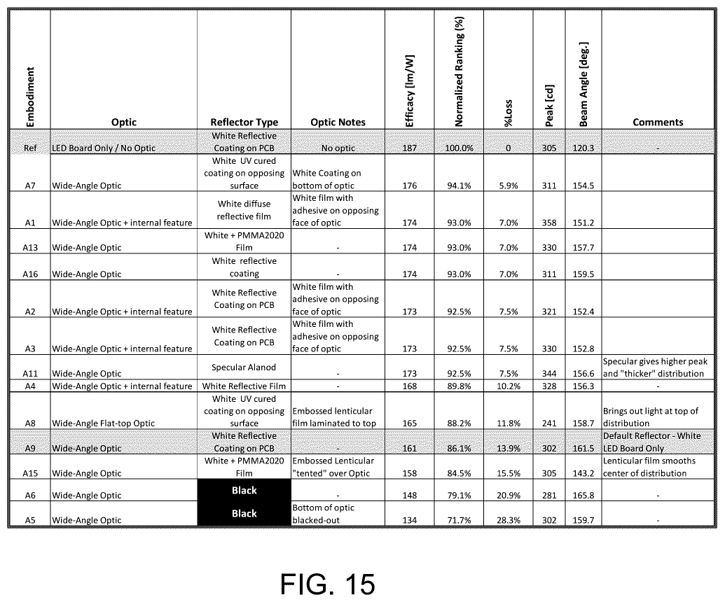

FIG. 15 is a table of data from optical measurements performed on differing optical arrangement embodiments setup similar to the embodiment of FIG. 1C but with slight variation for each embodiment. The first row reference case is configured with no optical element and a white LED board as the light source board. This case is the highest efficacy and correspondingly has a normalized ranking of 100% in addition to efficacy in lumens/watt which evaluates total luminous output, there are metrics for peak intensity in candelas and beam angle in degrees. Important criteria not included in this table are glare, visual appearance of the optical element during on and off states, and the visual appearance of the light distribution as projected onto surface. All of the embodiments showed advantages for at least some of these criteria vs. typical commercial lighting optical systems. Embodiment A9 can be considered a second reference as it contains as a reflective backing layer only the surface of a standard white LED board. Compared to that with a normalized efficacy ranking of 86%, options with inserted or optically coupled reflective backing layers showed improved efficacy with the optically coupled options (coating or laminating onto the opposing surface of the optical element) showing the highest efficacy at 93-94% as compared to the reference without optical element. Embodiments A5 and A6 had the lowest efficacy due to a black reflective backing layer film (A6) and a black coating onto the opposing surface of the optical element (A5). Despite the black backing layer, normalized values were over 70% at 79% and 72% respectively and the appearance of the embodiments in the off state is very black, a unique and desirable aesthetic for some applications where the efficacy tradeoff is acceptable.

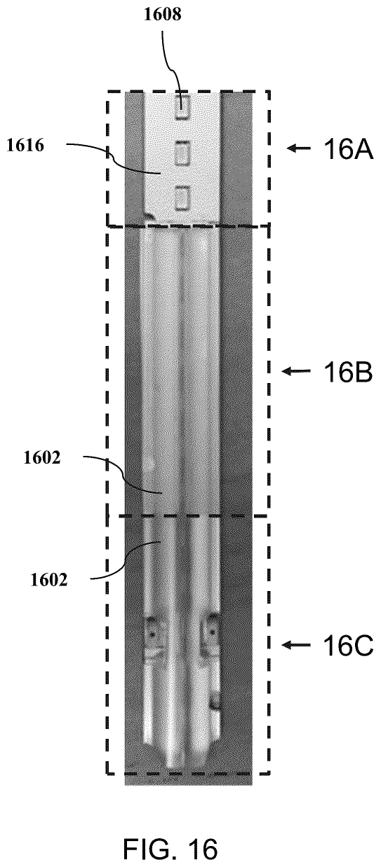

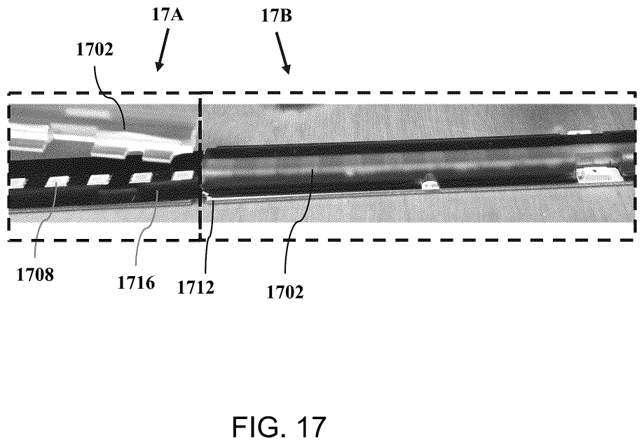

FIG. 16-19 illustrate the visual appearance effects of specific embodiments, FIG. 16 being focused on the appearance of embodiments with differing white backing layer options and FIG. 17-19 documenting appearance of embodiments having black backing layers.

FIG. 16 is a head-on photo comparing the visual appearance of an optical arrangement with and without white backing layers optically coupled to the optical element. The image of FIG. 16 is segmented into 3 zones, 16A, 16B, and 16C. Zone 16A shows the underlying white LED board including LEDs 1608 protruding through the white backing layer stencil 1616 covering the LED board. There is no optical element in zone 16A. Zone 16B shows the white backing layer stencil 1616 optically coupled, laminated in this case, to the opposing side (back side in this view) of the optical element 1602. Zone 16C shows the optical element 1602 positioned on top of, but not optically coupled to the white backing layer stencil film 1616. Comparing the visual appearance of the optical element with (Zone 16B) and without (Zone 16C) optical coupling shows that the optically coupled embodiment of Zone 16B is significantly more uniform in appearance than the Zone 16C uncoupled embodiment. This appears to be due to more internal specular reflected light inside the uncoupled Zone 16C embodiment. Ambient light from the room is entering both embodiments but is more diffusely reflected within the Zone 16B optically coupled embodiment. In alternative embodiments other colors, patterns, and/or images can be optically coupled to the opposing face of an optical element to create an appearance significantly the same as the optically coupled backing layer. For example, the applied backing layer could be made to look like a wall or ceiling so that an optical element can be visually suppressed or hidden from view.

FIG. 17 shows an image of embodiment A6 from the table in FIG. 15. The photo image is divided into two zones; the exploded view of Zone 17A and the assembled view of Zone 17B. Zone 17A shows the black backing layer stencil 1716 layered on top of the LED board 1712. Visible through the black backing layer stencil are LEDs 1708. The optical element 1702 is raised off of the black backing layer stencil. In Zone 17B, the optical element 1702 is positioned onto the black backing layer stencil but not optically coupled. The image of the optical element in the assembled Zone B configuration is dark with a small amount of internal reflection.

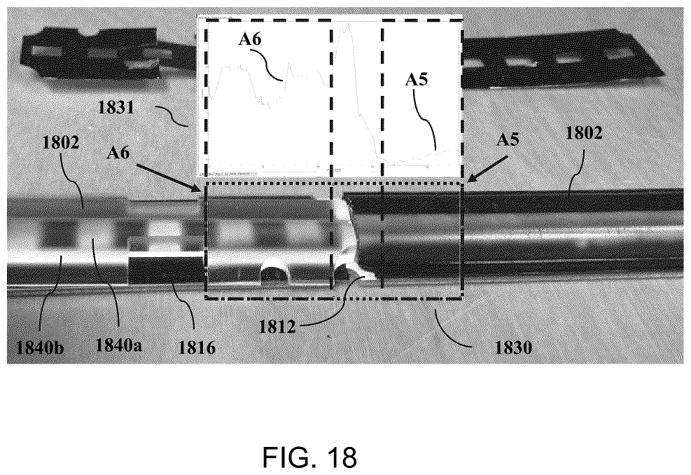

FIG. 18 compares embodiments A5 and A6 from the table in FIG. 15. Both embodiments have the same LED board 1812 and black backing layer stencils but differ in that embodiment A5 has a black coating optically coupled to the opposing side of the optical element 1802 while embodiment A6 has a black backing layer which is a black stencil 1816. Within the image of FIG. 18, there is an image Zone 1830 that is divided into Zone A6 (left side) that is an image of the uncoupled embodiment and Zone A5 (right side) that is an image of the optically coupled A5 embodiment. Also in FIG. 18 is superimposed in alignment with the image zone 1830 is an intensity plot 1831 which shows grayscale brightness values for each embodiment A6 and A5. Clearly the optically coupled embodiment A5 is visually much darker than the non-coupled A6 embodiment and this is demonstrated in the intensity plot of gray scale values. Visible in the image of FIG. 18 embodiment A6 are bright regions 1840a and 1840b which appear to be caused by specular internal reflection within the optical element 1802 of ambient light from overhead lights within the room. The black optically coupled coating of embodiment A5 appears to be suppressing or eliminating internal specular reflection within the optical element.

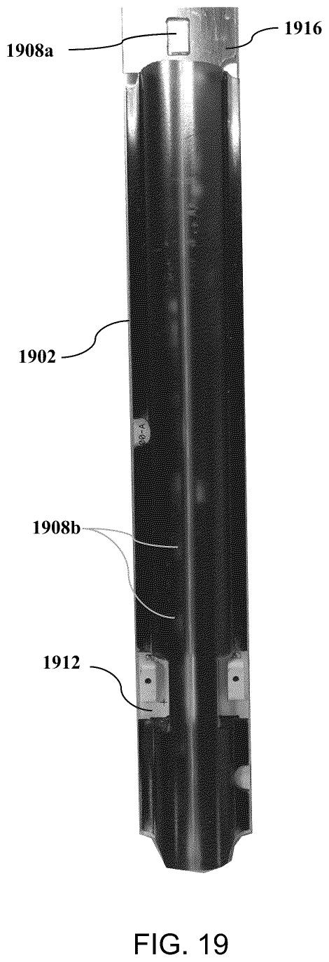

FIG. 19 is a head-on view of embodiment A5 from the table in FIG. 15 and illustrates a very dark appearance. This embodiment has an optical element 1902 with an optically coupled black coating on the opposing surface and is positioned on a black backing layer stencil 1916 itself positioned on a white LED board 1912. LED 1908a is visible through the black backing layer stencil in a section of the image where the optical element is removed but LEDs 1908b covered by the optical element 1902 are barely visible.

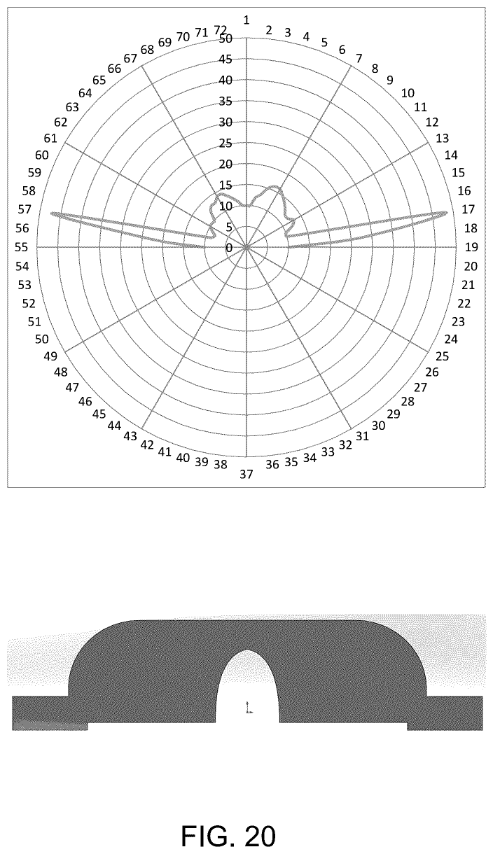

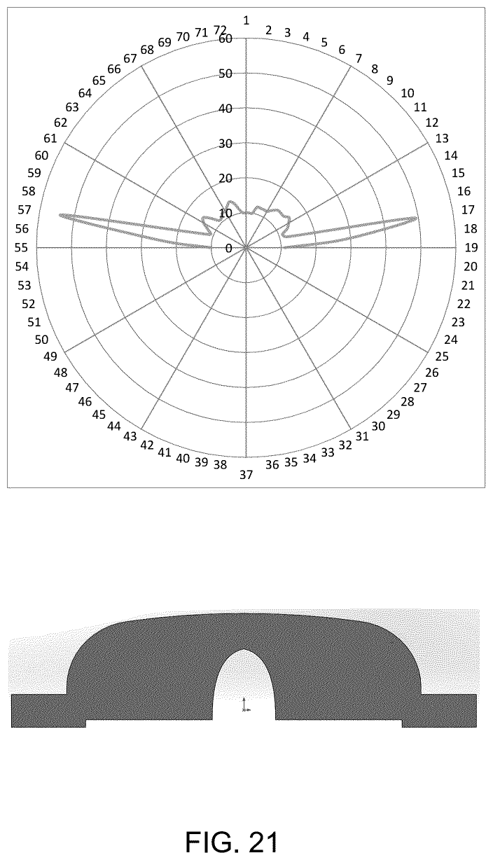

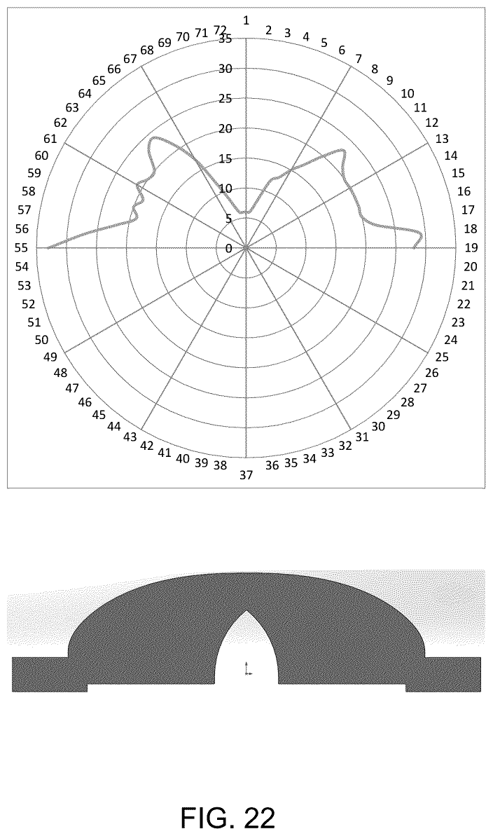

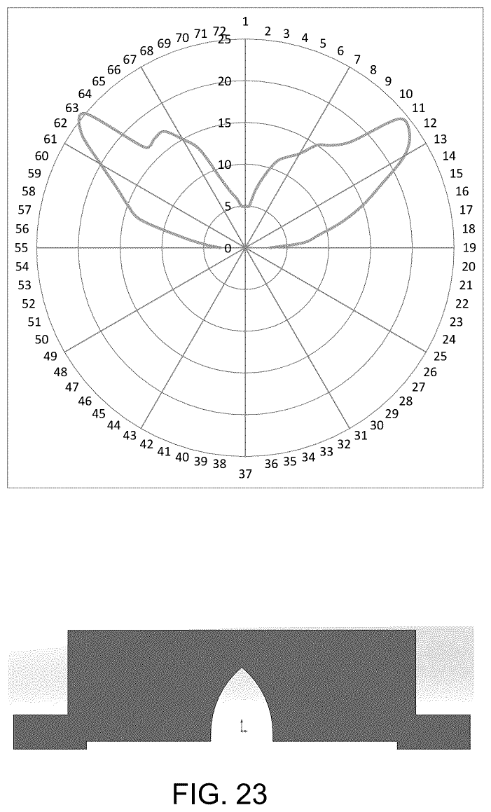

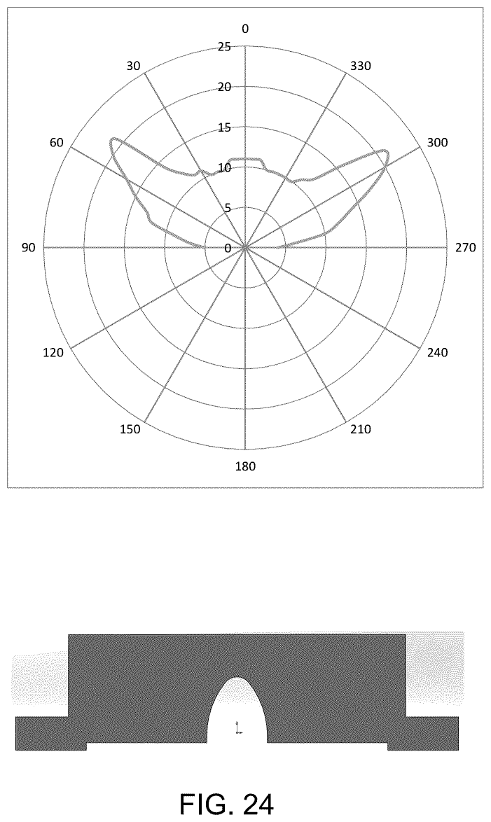

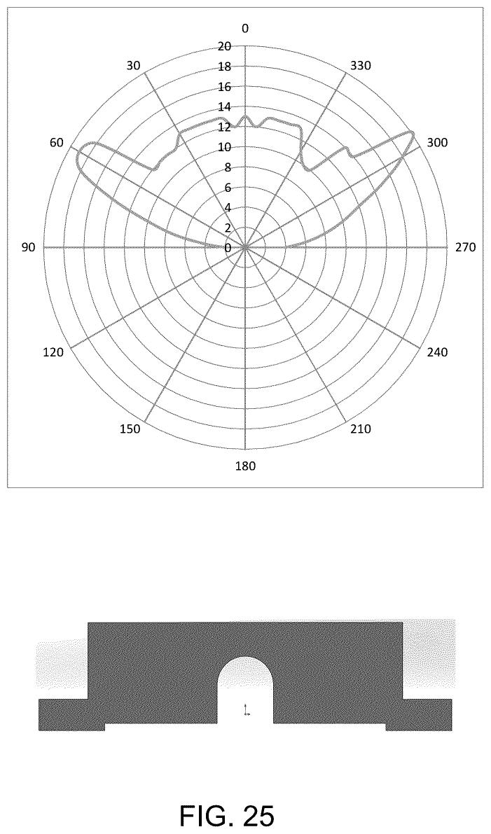

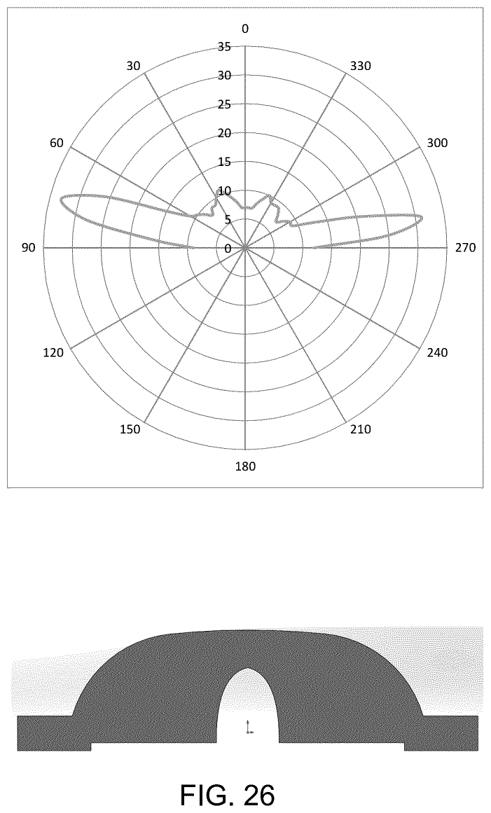

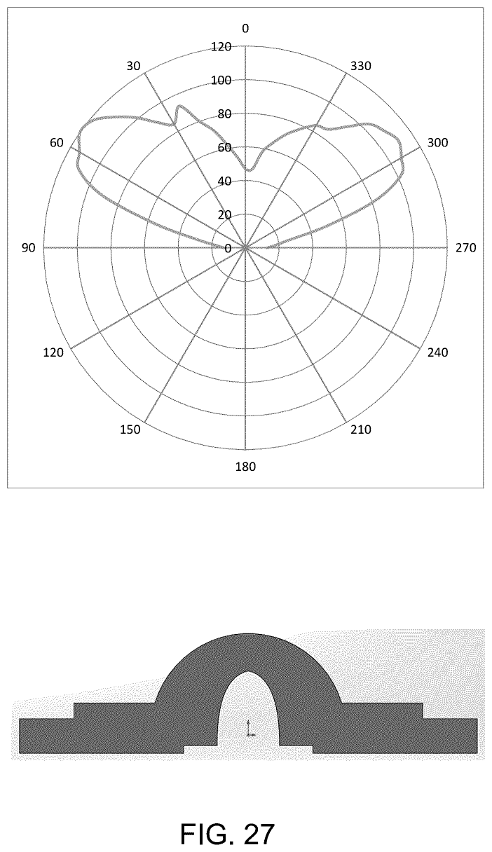

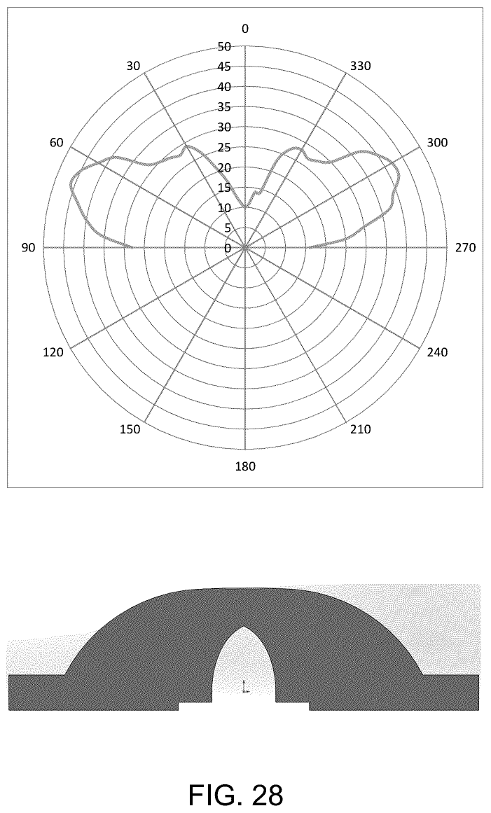

FIG. 20-28 illustrate embodiment polar plot light distributions achieved with a corresponding different optical element geometry shown in each figure.

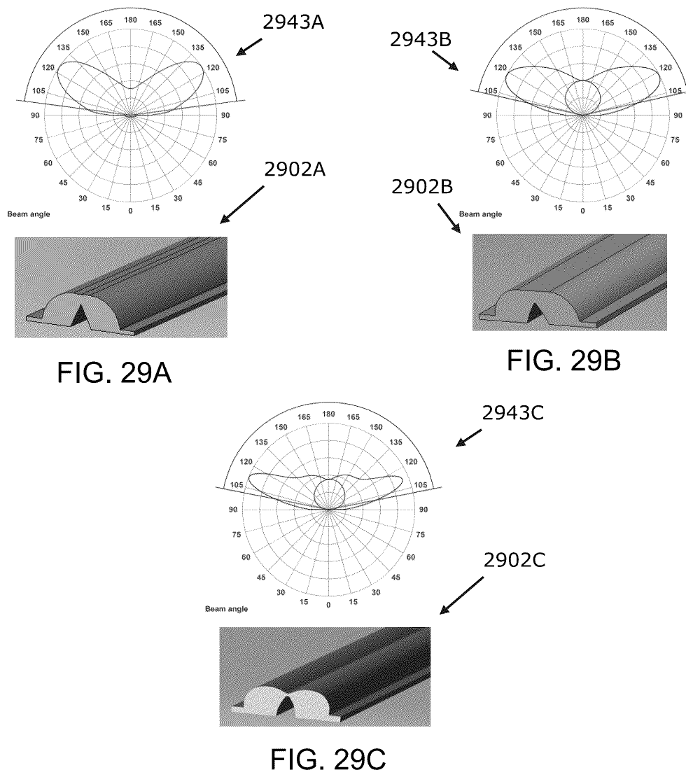

FIG. 29A-29C show three different optical elements and the corresponding polar plot light distribution produced in an optical arrangement having a white backing layer film stacked adjacent to the opposing face as in FIG. 1C. The geometry of each optical element 2902(A-C) varies in a way that alters the corresponding light distribution 2943(A-C) which vary in beam spread.

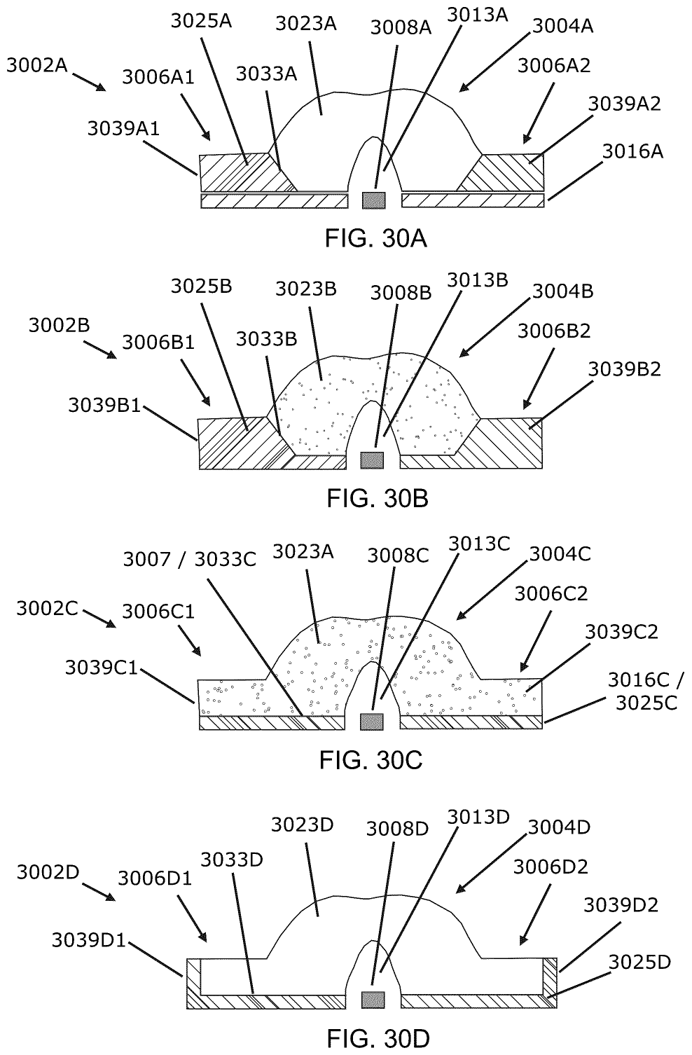

FIG. 30A-30D illustrate a range of embodiment optical arrangements with various optical composite elements comprised of multiple materials. In FIGS. 30A and 30B, a first portion 3004 of the optical element 3002 is comprised of a light transmissive material 3023 and a second portion 3006 is comprised of a reflective or transflective material 3025. In FIGS. 30A-30D, the light transmissive materials 3023 could be either optically clear (as depicted in FIGS. 30A & FIG. 30D) or optically diffuse (as depicted in FIG. 30B-C). A light source 3008 emits light into an optical cavity 3013 within the first portion of the optical element 3004. FIG. 30A additionally comprises a backing layer 3016A which in alternative embodiments could be a reflective layer, an absorbing layer, or a decorative patterned or colored layer. In the embodiment of FIG. 30A, the separate backing layer 3016A is not optically bonded to the optical element. Rather, there is an air interface between the two. In the embodiment of FIG. 30C, a reflecting material 3025C composes a backing layer 3016C which has an optically coupled interface 3033C with the entire opposing face 3307 of the optical element. In FIG. 30D, the reflective material 3025D and optically coupled interface 3033D wraps around the flange ends 3039D1-D2.

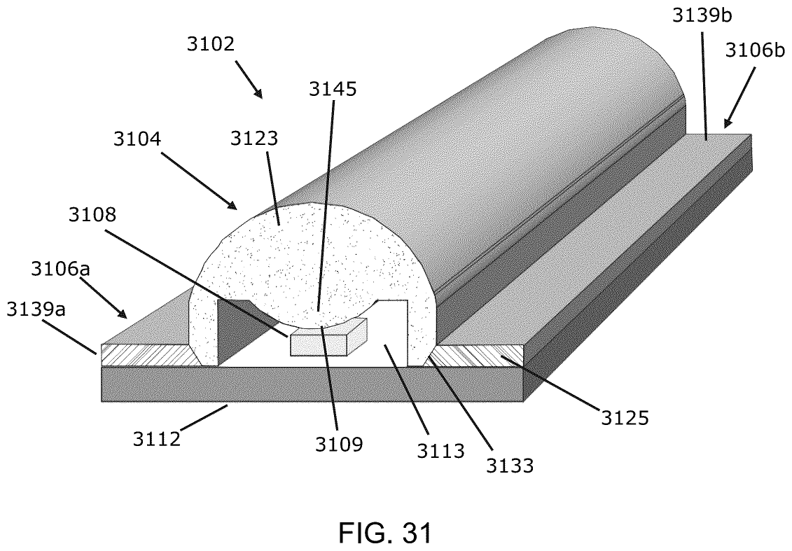

FIG. 31 illustrates an embodiment optical arrangement with an optical composite element 3102 having a collimating lens structure in the first portion 3104 of the optical element to produce a narrow collimated beam of light using the light transmissive material 3123. The second portions 3106a-b in this embodiment may be a reflective white material 3125 to prevent light from the optical cavity 3133 from propagating into the second portions. The second portions can serve as mounting flanges 3139 and as illustrated in this particular embodiment can be mated with the LED board 3112 containing a linear series of LED light sources 3108.

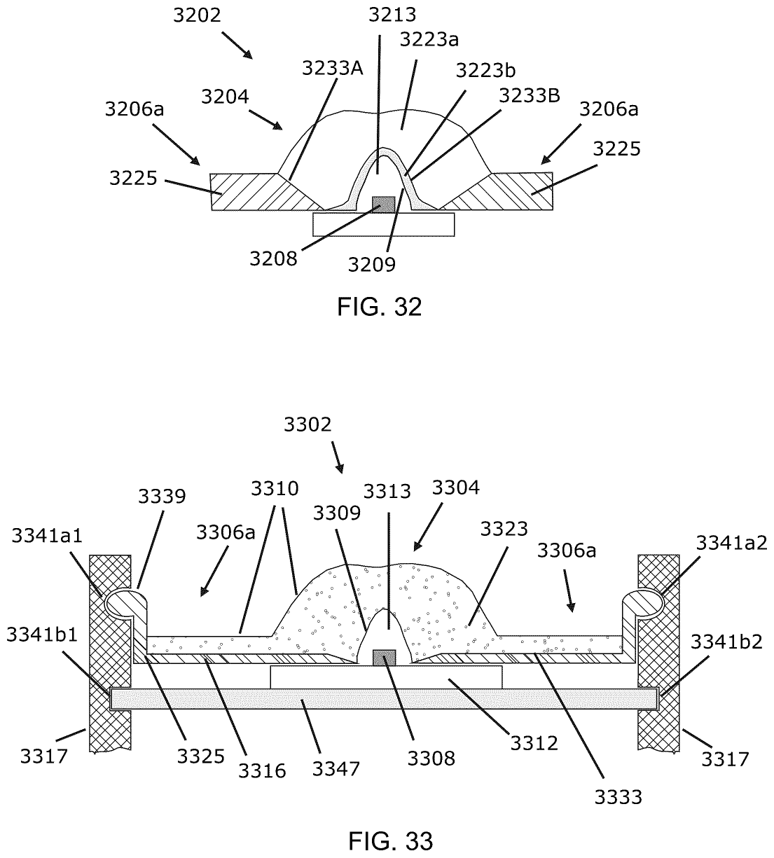

FIG. 32 is a cross-section view illustrating an embodiment optical arrangement with an optical composite element 3202 comprising three materials; a clear light transmissive material 3223a, a diffuse light transmissive material 3223b, and a reflective material 3225. The diffuse light transmissive material 3223b lessens the brightness of the light source 3208 with minimal transmission loss while the clear light transmissive material 3223a forms a lens structure for directing the light output.

FIG. 33 is a cross-section view illustrating an embodiment optical arrangement with an optical composite element 3302, LED board 3312, and gear tray 3347 configured to mount into a housing 3317. Mounting tabs 3339 of the optical element second portions 3306 fit into mounting slots 3341a1-a2 within the housing 3317. The LED board 3312 is fastened to the gear tray 3347 which fits into mounting slots 3341b1-b2. Thus, the entire optical arrangement is held in place in a position of optical alignment. Reflective material 3325 composes both the backing layer 3316 and mounting tabs 3339 of the optical composite element. Light transmissive material 3323 comprises the entire output face 3310 of the optical composite element. In general, optical composites have advantages in reducing the number of components and simplifying assembly and that is the particularly the case in the embodiments of FIG. 33 and FIG. 35.

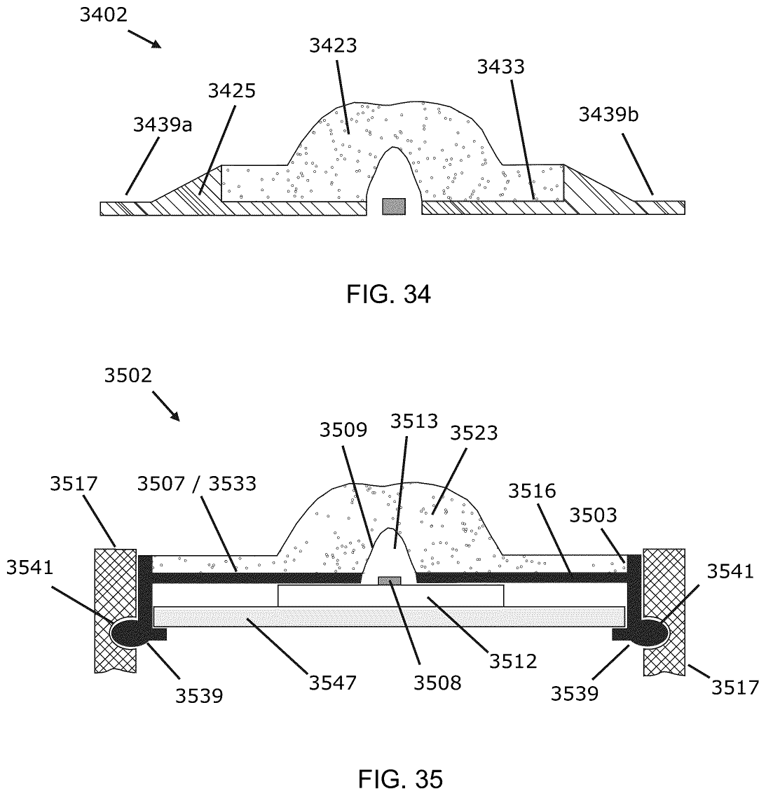

FIG. 34 is a cross-section view illustrating an embodiment optical arrangement with an optical composite element 3402 having extended second portion flanges 3439 for mounting within an optical assembly.

FIG. 35 is cross-section view of an embodiment optical arrangement with an optical composite element 3502 having a black backing layer 3516 optically coupled to the opposing face 3507 of the optical composite element. The optically coupled interface 3533 between light transmissive material 3523 and black backing material extends around the edge face 3503 of the optical element. With this optical arrangement internal reflection from ambient light is suppressed and there is a matte black unusually low visibility appearance to the optical composite element when the light source is not on. The optically coupled black backing layer also absorbs internal reflections within the optical element when the light source is on, thereby providing a unique sharp appearance. The mounting tabs 3539 of the optical element fit into mounting slots 3541 within the housing 3517. The LED board 3312 is fastened to the gear tray 3347. The gear tray is held in position by the mounting tabs 3539.

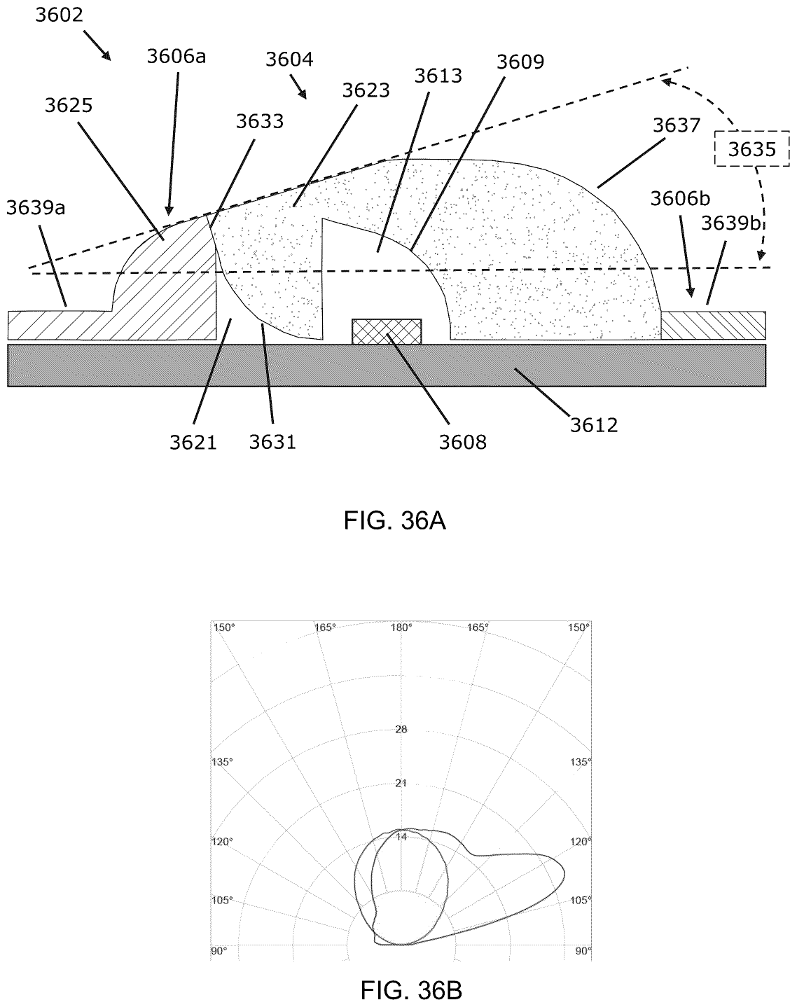

FIG. 36A is a cross-section view of an embodiment optical arrangement with an optical composite element 3602 having a configuration to produce an asymmetric light distribution. The optical composite element is positioned on an LED board 3612 having a linear array of LED light sources 3608 so that light is emitted into the light input optical cavity 3613 and subsequently propagates into the light transmissive material 3623 of the first portion 3604 of the optical composite element. The non-input optical cavity 3621 creates a TIR interface 3631 which substantially redirects light away from the TIR interface to contribute to an asymmetric light distribution as illustrated in the polor plot of FIG. 36B. Also contributing to the asymmetric output is the region of decreased lens radius 3637 and the asymmetric lens slope 3635. Side portions 3606 contain a reflective material 3625 that additionally redirects light including at an optically coupled interface 3633. Mounting flanges 3639 are in this embodiment comprises of reflective material 3625.

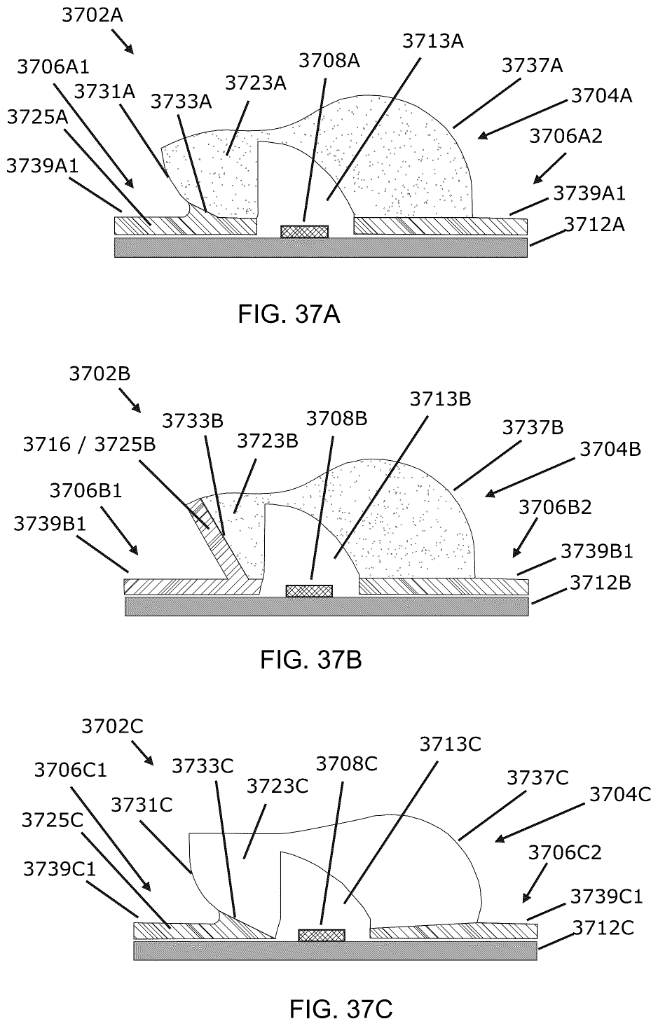

FIGS. 37A-37C show cross-section views of embodiment optical arrangements with optical composite elements configured for asymmetric light distributions. First portion regions are comprised of light transmissive material 3723 and second portion regions comprise backing layers, which can be reflective with the use of a reflecting material 3725. The second portions further comprise mounting flanges for attachment to lighting assemblies. Unlike the optical composite element of FIG. 36A, there is no non-optical cavity inside the first portion 3704. Rather, in FIGS. 37A and 37C there is a TIR interface 3731 on the exterior of the first portion in order to contribute to asymmetric light output. In FIG. 37B the optically coupled interface 3733B between light transmissive material 3723 and backing layer 3716 is tilted in angle with respect to the LED board 3712B and substantially large in surface area to contribute significantly to asymmetric output.

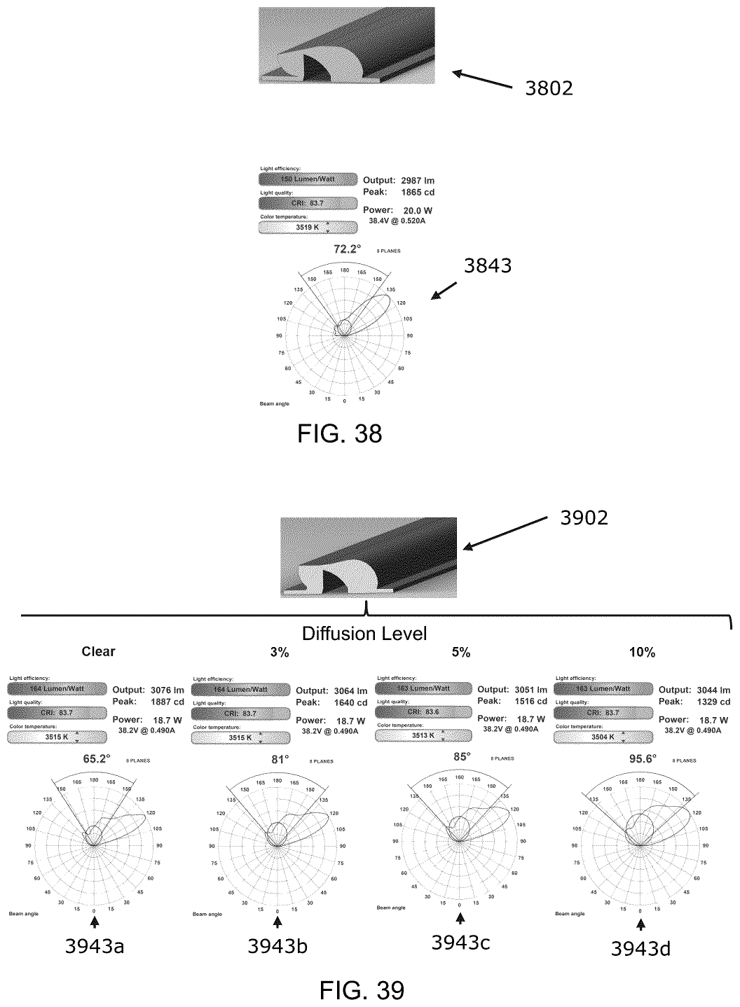

FIG. 38 illustrates a particular optical element embodiment 3802 used in an optical arrangement configuration to produce the illustrated photometric data and polar plot of asymmetric light distribution 3843.

FIG. 39 illustrates a particular optical element embodiment 3902 used in an optical arrangement configuration to produce the illustrated photometric data and polar plots of asymmetric light distributions 3943a-d which correspond to differing diffusion levels of 0%, 3%, 5%, and 10%. It can be seen from the series of polor plots that the beam width increases with increasing diffusion level.

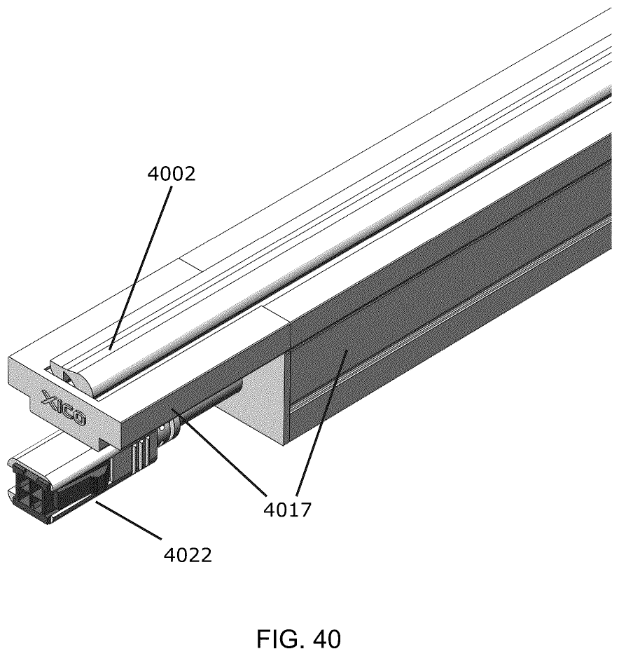

FIG. 40 illustrates a cove light fixture with an embodiment optical arrangement. The optical element 4002 is positioned in the housing 4017. An electrical connector 4022 is used to join light fixture sections which may optionally have an LED driver inside the housing or alternatively be powered by a remote LED driver.

Modifications to embodiments of the present disclosure described in the foregoing are possible without departing from the scope of the present disclosure as defined by the accompanying claims. Expressions such as “including”, “comprising”, “incorporating”, have”, “is” used to describe and claim the present disclosure are intended to be construed in a non-exclusive manner, namely allowing for items, components or elements not explicitly described also to be present. Reference to the singular is also to be construed to relate to the plural.

### LISTING OF NUMERICAL LABELS

“x” indicates the number of a specific FIG.
x00 optical arrangement
101 light ray
x02 optical element/optical composite element
x03 edge face of optical element
x04 first portion of optical element
105 angular input angle of optical element
x06 second portion of optical element
x07 opposing face of optical element
x08 light source (single or series)
x09 input face of optical element
x10 output face of optical element
x12 light source board/printed circuit board/PCB
x13 light input optical cavity
114 base support of housing
x16 backing layer (reflective, white, black, other)
x17 housing
118 aperture
111 angular input range to secondary reflector
x19 supplemental lens
120 inward facing lips of housing
x21 non-input optical cavity/TIR interface
x22 electrical connector
x23 light transmissive material
x25 light reflective material
x27 transflective material
x29 light absorbing material
x31 TIR interface
x33 optically coupled interface
x35 asymmetric lens slope
x37 decreased lens radius region
x39 mounting flange/tab
x41 mounting slot
x43 light distribution
x45 collimating lens structure
x47 gear tray
520 leg region of second portion of optical element
621 light scattering layer
722 surface features
1110 mounting rails
1016 reflecting strip
1023 light transmitting surfaces
1124 slot in second slot of optical element
1226 internal support rail
1830 image zone
1831 intensity plot
1840 bright regions

What is claimed is:

1. An optical composite comprising:
A) a first portion comprising a volume of light transmissive material further comprising;
1) an output face having at least one lens curvature;
2) an internal cavity within the first portion with an input face formed by the boundary of the internal cavity;
B) a second portion comprising a volume of backing material;
C) at least one optically coupled interface between the first portion and the second portion.

2. The optical composite of claim 1 wherein the light transmissive material is comprised of a bulk light transmissive material further comprising distributed light scattering features.

3. The optical composite of claim 2 wherein the light scattering features are comprised of dispersed regions of differing refractive index than the bulk light transmissive material.

4. The optical composite of claim 1 wherein the backing material is substantially reflective.

5. The optical composite of claim 1 wherein the backing material is substantially white.

6. The optical composite of claim 1 having the three dimensional form of a two dimensional cross sectional profile area linearly extruded in a longitudinal direction.

7. The optical composite of claim 1 wherein the optically coupled interface reflects light into the lens portion of the optical composite.

8. The optical composite of claim 1 wherein the backing material is opaque to light transmission.

9. The optical composite of claim 1 wherein the backing material is a transflective material that is partially reflective and substantially but less light transmissive than the light transmissive material of the lens portion.

10. The optical composite of P wherein the transflective material is comprised of dispersed regions of refractive index higher than the bulk material.

11. The optical composite of claim 1 formed by a coextrusion process of at least one light transmissive material and at least one backing material.

12. The optical composite of claim 1 wherein the optically coupled interface is formed when one or both of the light transmissive material and backing material are in liquid state.

13. The optical composite of claim 1 wherein the second portion of the optical composite further comprises a connecting portion for connection with a housing.

14. The optical composite of claim 13 wherein the connecting portion comprises a flange or tab feature.

15. The optical composite of claim 1 wherein the first portion of the optical composite is a mechanical bridging component between at least two second portions of the optical composite.

16. The optical composite of claim 1 wherein the lens feature is that of a convex lens.

17. The optical composite of claim 1 wherein the backing material is black.

18. An optical arrangement comprising:
A) an optical composite comprising;
1) a first portion comprising a volume of light transmissive material further comprising;
a. an output face having at least one lens curvature;
b. an internal cavity within the first portion with an input face formed by the boundary of the internal cavity;
2) a second portion comprising a volume of light backing material;
B) at least one optically coupled interface between the first portion and the second portion;
C) an LED board comprising at least one LED light source and a printed circuit board wherein the LED board is arranged to input light into the internal cavity such that light emitted from at least one LED light source enters the input face of the optical element.

19. The optical arrangement of claim 18 wherein the second portion of the optical composite further comprises a connecting portion for connection with a housing.

20. The optical arrangement of claim 19 wherein the connecting portion comprises a flange or tab feature.

21. The optical arrangement of claim 19 further comprising a housing with one or more slots into which a connecting portion can be inserted.

22. The optical arrangement of claim 19 wherein the LED board is held in position by the connecting portion.

23. The optical arrangement of claim 18 wherein the lens curvature of the first portion is configured to produce an asymmetric light distribution.

24. The optical composite of claim 23 wherein the first portion comprises an asymmetric lens slope.

25. The optical arrangement of claim 23 wherein the first portion comprises a decreased lens radius region.

26. The optical arrangement of claim 23 wherein the first portion further comprises a non-input optical cavity within the lens portion which creates in combination with the light transmissive material a TIR interface that redirect light to contribute to an asymmetric light distribution.

27. The optical arrangement of claim 1 wherein the lens curvature of the first portion produces a collimating optical effect.
